(19) United States
(12) Patent Application Publication
(10) Pub. No.: US 2026/0147287 A1
(43) Pub. Date: May 28, 2026

(54) TWO-COMPONENT DEVELOPER

(71) Applicant: CANON KABUSHIKI KAISHA, Tokyo (JP)

(72) Inventors: ICHIRO KANNO, Chiba (JP); KENTARO KAMAE, Kanagawa (JP); NOBUHIRO YOSHIDA, Ibaraki (JP); MIZUKI SAITO, Chiba (JP); KOHEI YOSHIYAMA, Chiba (JP); YUU NISHIMURA, Chiba (JP); TORU TAKAHASHI, Ibaraki (JP); TAKAHO SHIBATA, Tokyo (JP)

(21) Appl. No.: 19/383,457

(22) Filed: Nov. 7, 2025

(30) Foreign Application Priority Data
Nov. 26, 2024 (JP) 2024-205846

(51) Int. Cl. G03G 9/107; G03G 9/08; G03G 9/113

(52) U.S. Cl. CPC G03G 9/107; G03G 9/0808; G03G 9/1133; G03G 9/1139

(57) ABSTRACT

A two-component developer includes a toner particle, a magnetic carrier particle, and an inorganic fine particle B. The magnetic carrier particle includes a coating resin layer coating a magnetic core particle and including an inorganic fine particle A. At least part of the inorganic fine particle A is exposed on the carrier particle surface. A recovery amount XB of the inorganic fine particle B recovered by a water washing method is 0.01 to 0.05 parts by mass. The inorganic fine particle B has a compression energy of 75 mJ or less. The inorganic fine particles A and B satisfy designated relationship.

### BACKGROUND

### Field of the Technology

The present disclosure relates to a two-component developer used in electrophotographic image forming methods.

### Description of the Related Art

Recent years have continued to see rising expectations on electrophotography for higher speed, higher image quality, and higher stability. In order to achieve higher quality and higher stability, it is necessary that high image reproducibility be achieved during the processes such as development, transfer, and fixing, in any service environment.

A typical electrophotographic image forming method has involved forming an electrostatic latent image on an electrostatic latent image bearing member by any type of system and attaching a toner to the electrostatic latent image to develop the electrostatic latent image. For this development, a two-component development system has been widely adopted in which support particles called a magnetic carrier are mixed with a toner, the toner is given an appropriate amount of positive or negative charges by triboelectric charging, and these charges are used as a driving force of the development.

According to the two-component development system, since functions such as stirring, conveying, and charging the developer can be assigned to the magnetic carrier, there is clarity as to which functions are to be allocated to the magnetic carrier and the toner, and this provides an advantage of good developer performance controllability. The magnetic carrier concerned here often has a structure that includes a magnetic core for acquiring conveyability by magnetization, and a coating resin that coats the magnetic core and allows the toner to acquire the charge-imparting performance.

The density of an electrophotographically formed image fluctuates by the influence of the charge amount of the toner, and thus it is common practice for an electrophotographic image forming apparatus to have installed therein a mechanism that keeps the final image density constant by adjusting the developing conditions. However, it is known that, when a large number of printouts are made and the charge amount fluctuation beyond the adjustment range occurs due to such a factor as degraded durability of the developer caused by stirring inside the developing machine, there arises disadvantages such as decreased image density caused by an excessively large charge amount and, conversely, contamination in the device by the toner scattering caused by a deficient charge amount. These disadvantages tend to arise extensively in an image forming apparatus structure that meets recent needs for high image quality and high speed, and thus an invention of a developer that improves both of these properties is desired.

In a two-component development system, the charge properties of the toner can be changed by the configuration of the magnetic carrier described above, and, in particular, a magnetic carrier in which the structure of the coating resin layer is addressed is known.

Japanese Patent Laid-Open No. 2023-047232 proposes a carrier for an electrophotographic dry developer, the carrier including a core material and a coating layer on a surface of the core material, the coating layer containing a cyclohexyl acrylate resin containing silica particles.

Japanese Patent Laid-Open No. 2023-162570 proposes a carrier for an electrophotographic dry developer, the carrier including a core material, a coating layer containing a polyimide resin and fluorine resin particles, and a coating layer containing a silicone resin and barium titanate particles, the coating layers being disposed on a surface of the core material.

According to developers that use the carriers disclosed in Japanese Patent Laid-Open Nos. 2023-047232 and 2023-162570, the charge amount of the developer tends to decrease in a high-temperature, high-humidity environment due to the degraded durability of the developer.

### SUMMARY

The present disclosure provides a two-component developer that can suppress a decrease in charge amount of the developer caused by degraded durability of the developer in a high-temperature, high-humidity environment.

According to an aspect of the present disclosure, there is provided a two-component developer including a toner particle, a magnetic carrier particle, and an inorganic fine particle B. The magnetic carrier particle includes a magnetic core particle and a coating resin layer coating a surface of the magnetic core particle. The coating resin layer includes an inorganic fine particle A. At least part of the inorganic fine particle A is exposed on a surface of the magnetic carrier particle. XB (parts by mass) representing a recovery amount of the inorganic fine particle B recovered from the two-component developer by a water washing method is 0.01 parts by mass to 0.05 parts by mass per 100 parts by mass of the magnetic carrier particle. The inorganic fine particle B has a compression energy of 75 mJ or less as measured in a state of a powder layer formed by compression at 30 kPa. WA (eV) representing a work function of the inorganic fine particle A and WB (eV) representing a work function of the inorganic fine particle B satisfy formula (1): 0.5≤|WA−WB|≤10.0 (1). XA (area %) representing a coverage of the surface of the magnetic carrier particle by the inorganic fine particle A and the XB satisfy formula (2): 0.001≤XB/XA≤0.010 (2). HA (nm) representing an average value of a height of a protrusion of the inorganic fine particle A exposed on the surface of the magnetic carrier particle and HB (nm) representing a number average particle diameter of primary particles of the inorganic fine particle B recovered by the water washing method satisfy formula (3): 0.5≤HB/HA≤4.0 (3).

Features of the present disclosure will become apparent from the following description of embodiments with reference to the attached drawings. The following description of embodiments is described by way of example.

### BRIEF DESCRIPTION OF THE DRAWINGS

FIG. 1 is an image of a magnetic carrier by surface observation with a SEM.

FIG. 2 is a schematic diagram illustrating a method for measuring the height of a protrusion of an inorganic fine particle exposed on a surface of a magnetic carrier particle.

### DESCRIPTION OF THE EMBODIMENTS

Hereinafter, the present disclosure is described in detail but the following descriptions do not limit the present disclosure. In the present disclosure, phrases indicating numerical ranges, such as “XX or more and YY or less” and “XX≤ or ≤YY”, are numerical ranges inclusive of end points, that is, the lower limit and the upper limit, unless otherwise noted. When numerical ranges are expressed stepwise, the upper limit and the lower limit of each numerical range can be combined as desired.

The present disclosure relates to a two-component developer including a toner particle, a magnetic carrier particle, and an inorganic fine particle B. The magnetic carrier particle includes a magnetic core particle and a coating resin layer coating a surface of the magnetic core particle. The coating resin layer includes an inorganic fine particle A. At least part of the inorganic fine particle A is exposed on a surface of the magnetic carrier particle. XB (parts by mass) representing a recovery amount of the inorganic fine particle B recovered from the two-component developer by a water washing method is 0.01 parts by mass to 0.05 parts by mass per 100 parts by mass of the magnetic carrier particle. The inorganic fine particle B has a compression energy of 75 mJ or less as measured in a state of a powder layer formed by compression at 30 kPa. WA (eV) representing a work function of the inorganic fine particle A and WB (eV) representing a work function of the inorganic fine particle B satisfy formula (1): 0.5≤|WA−WB|≤10.0. XA (area %) representing a coverage of the surface of the magnetic carrier particle by the inorganic fine particle A and the XB satisfy formula (2): 0.001≤XB/XA≤0.010. HA (nm) representing an average value of a height of a protrusion of the inorganic fine particle A exposed on the surface of the magnetic carrier particle and HB (nm) representing a number average particle diameter of primary particles of the inorganic fine particle B recovered by the water washing method satisfy formula (3): 0.5≤HB/HA≤4.0.

When the two-component developer of the present disclosure satisfies the aforementioned features, the decrease in charge amount of the developer caused by degraded durability of the developer in a high-temperature, high-humidity environment can be suppressed. The specific mechanism therefor is presumably as follows.

Coating a surface of a magnetic core particle of the magnetic carrier particle with a coating resin layer containing an inorganic fine particle can suppress changes in charge amount caused by changes in humidity since the inorganic fine particle has properties of absorbing moisture. The effect of suppressing the change in charge amount described above is easily obtained when the inorganic fine particle is exposed on the surface of the magnetic carrier particle. However, extensive studies conducted by the inventors of the present disclosure have found that a coating resin layer in which an inorganic fine particle is exposed on the surface of the magnetic carrier particle is more prone to wearing caused by interparticle contact of the magnetic carrier particle than a coating resin layer in which the inorganic fine particle is not exposed on the surface of the magnetic carrier particle. Specifically, when the number of printouts made is large and the developer is more frequently stirred in the developing machine by replenishment operation, this wear occurs more prominently. When the coating resin layer becomes worn, the resistance of the magnetic carrier particle increases, and thus the charge amount as the developer is likely to decrease.

To address this, the inventors of the present disclosure have studied the way to suppress wearing of the coating resin layer, which is caused by interparticle contact of the magnetic carrier particle, by adding, to a developer, an inorganic fine particle having a low friction coefficient and by placing adjacent to each other the inorganic fine particle exposed on the surface of the magnetic carrier particle and the inorganic fine particle having a low friction coefficient. Specifically, by adding, to a developer, an inorganic fine particle having a low friction coefficient and having a work function different from that of the inorganic fine particle exposed on the surface of the magnetic carrier particle, the inorganic fine particle exposed on the surface of the magnetic carrier particle and the inorganic fine particle having a low friction coefficient can be placed adjacent to each other. As a result, the friction coefficient of the surface of the magnetic carrier particle decreases, and the stress caused by interparticle collision of the magnetic carrier particle is alleviated; thus, wearing of the coating resin layer is suppressed, and the decrease in charge amount of the developer can be suppressed.

Each of the features of the present disclosure will now be described in detail.

The two-component developer of the present disclosure includes a toner particle, a magnetic carrier particle, and an inorganic fine particle B.

In addition, XB (parts by mass) representing a recovery amount of the inorganic fine particle B recovered from the two-component developer by a water washing method is 0.01 parts by mass to 0.05 parts by mass per 100 parts by mass of the magnetic carrier.

When XB is 0.01 parts by mass to 0.05 parts by mass, the inorganic fine particle A exposed on the surface of the magnetic carrier particle and the inorganic fine particle B can come adjacent to each other, and an effect of suppressing wearing of the coating resin layer caused by interparticle contact of the magnetic carrier particle and an effect of improving the charging stability can be obtained. XB may be 0.01 parts by mass to 0.03 parts by mass. The details of the water washing method are described below.

The inorganic fine particle B has a compression energy of 75 mJ or less as measured in a state of a powder layer formed by compression at 30 kPa. When the compression energy is 75 mJ or less, the inorganic fine particle B adjacent to the inorganic fine particle A exposed on the surface of the magnetic carrier particle decreases the friction coefficient of the surface of the magnetic carrier particle, and thus wearing of the coating resin layer caused by interparticle contact of the magnetic carrier particle can be suppressed. The compression energy can be 65 mJ or less from the viewpoint of suppressing wearing of the coating resin layer.

Furthermore, the compression energy can be 5 mJ or more from the viewpoint of development stability.

The work function WA (eV) of the inorganic fine particle A and the work function WB (eV) of the inorganic fine particle B satisfy formula (1) below:

$$0.5 \leq \vert WA - WB \vert \leq 10. \qquad ( 1 )$$

A work function is a minimum energy (eV) needed to take out one electron from a substance surface to infinity. When WA and WB satisfy formula (1) above, the triboelectric series of the inorganic fine particle A and the inorganic fine particle B are sufficiently apart from each other and thus it becomes easier for the inorganic fine particle A and the inorganic fine particle B to come adjacent to each other. |WA−WB| can be 0.5 eV or more and 5.2 eV or less from the viewpoint of enhancing the effect of placing the inorganic fine particle A exposed on the surface of the magnetic carrier particle to be adjacent to the inorganic fine particle B and from the viewpoint of charging stability.

XA (area %) representing the coverage of the surface of the magnetic carrier particle by the inorganic fine particle A and XB satisfy formula (2) below:

$$0.001 \leq XB / XA \leq 0.010$$

When XA and XB satisfy formula (2) described above, the inorganic fine particle A exposed on the surface of the magnetic carrier particle and the inorganic fine particle B can be placed adjacent to each other, and wearing of the coating resin layer caused by interparticle contact of the magnetic carrier particle can be suppressed. XB/XA can be 0.001 or more and 0.003 or less. XA can be controlled by adjusting, for example, the number of parts of the inorganic fine particle A added to the coating resin coating the surface of the magnetic core particle. Note that the method for measuring the coverage XA is described in detail below.

HA (nm) representing an average value of a height of a protrusion of the inorganic fine particle A exposed on the surface of the magnetic carrier particle and HB (nm) representing a number average particle diameter of primary particles of the inorganic fine particle B recovered by the water washing method satisfy formula (3) below:

$$0.5 \leq HB / HA \leq 4.0$$

When HA and HB satisfy formula (3) described above, the inorganic fine particle A exposed on the surface of the magnetic carrier particle and the inorganic fine particle B can be placed adjacent to each other, and wearing of the coating resin layer caused by interparticle contact of the magnetic carrier particle can be suppressed. HB/HA can be 0.5 or more and 3.5 or less. HA can be controlled by the particle diameter and the specific gravity of the inorganic fine particle A. Note that the methods for measuring the average value HA of the height of the protrusion and the number average particle diameter HB of primary particles of the inorganic fine particle B recovered by a water washing method are described in detail below.

### Inorganic Fine Particle B

The two-component developer of the present disclosure contains an inorganic fine particle B that has a compression energy of 75 mJ or less as measured in a state of a powder layer formed by compression at 30 kPa. Any known inorganic fine particle can be selected and used as the inorganic fine particle B as long as the compression energy is 75 mJ or less. Examples thereof include a strontium titanate fine particle, a titanium oxide fine particle, and a silica fine particle.

The inorganic fine particle B can be a strontium titanate fine particle from the viewpoint of suppressing wearing of the coating resin layer caused by interparticle contact of the magnetic carrier particle and from the viewpoint of suppressing the change in charge amount caused by changes in humidity.

The inorganic fine particle B of the present disclosure can be a surface-treated inorganic fine particle, and the surface treating agent can be at least one selected from the group consisting of a silane coupling agent, a fluorosilane coupling agent, a fatty acid, and a fatty acid metal salt from the viewpoint of suppressing wearing of the coating layer caused by interparticle contact of the carrier and the viewpoint of suppressing the change in charge amount caused by changes in humidity. In particular, the inorganic fine particle B can be a surface-treated inorganic fine particle, and the surface treating agent can be at least one selected from the group consisting of a silane coupling agent and a fluorosilane coupling agent.

For example, the two-component developer can be made to contain the inorganic fine particle B by externally adding the inorganic fine particle B to the toner particle.

### Magnetic Carrier

The magnetic carrier particle of the present disclosure (hereinafter may be simply referred to as a “magnetic carrier” or “carrier”) includes a magnetic core particle and a coating resin layer coating a surface of the magnetic core particle. The coating resin layer includes an inorganic fine particle A, and at least part of the inorganic fine particle A is exposed on a surface of the magnetic carrier particle.

### Magnetic Core Particle

A magnetic particle such as a typical ferrite or magnetite can be used as the magnetic core particle of the magnetic carrier particle. Alternatively, a magnetic core particle of a type in which a porous ferrite or magnetite particle is filled with a resin can be used.

In particular, a magnetic core of a type in which a porous magnetic particle is filled with a resin can be used from the viewpoint of decreasing the amount of magnetization of the magnetic carrier particle. Furthermore, a ferrite having a desired amount of magnetization can be obtained by changing the compositional ratio of the raw material metal oxide.

A copolymer resin used as a coating resin can be used as a resin that fills the pores of a porous magnetic particle; however, the resin is not limited to the copolymer resin and a known resin such as a thermoplastic resin or a thermosetting resin can be used.

The thermoplastic resin can be a copolymer used as the coating resin, and other examples of the thermoplastic resin are as follows: polystyrene, polymethyl methacrylate, styrene-acrylic acid ester copolymer, styrene-methacrylic acid ester copolymer, styrene-butadiene copolymer, ethylene-vinyl acetate copolymer, polyvinyl chloride, polyvinyl acetate, polyvinylidene fluoride resin, fluorocarbon resin, perfluorocarbon resin, solvent-soluble perfluorocarbon resin, polyvinylpyrrolidone, petroleum resin, novolac resin, saturated alkyl polyester resin, aromatic polyester resin such as polyethylene terephthalate, polybutylene terephthalate, and polyarylate, polyamide resin, polyacetal resin, polycarbonate resin, polyethersulfone resin, polysulfone resin, polyphenylene sulfide resin, and polyether ketone resin.

Examples of the thermosetting resin are as follows: phenolic resin, modified phenolic resin, maleic resin, alkyd resin, epoxy resin, acrylic resin, unsaturated polyesters obtained by polycondensation of maleic anhydride, terephthalic acid, and polyhydric alcohols, urea resin, melamine resin, urea-melamine resin, xylene resin, toluene resin, guanamine resin, melamine-guanamine resin, acetoguanamine resin, glyptal resin, furan resin, silicone resin, polyimides, polyamide-imide resin, polyetherimide resin, and polyurethane resin.

The magnetic core particle can have a volume distribution-based 50% particle diameter (D50) of 20 μm or more and 80 μm or less since the magnetic core particle can be evenly coated with a coating resin, the magnetic carrier adhesion can be avoided, and the density of the magnetic brushes for obtaining high-quality images becomes appropriate.

### Coating Resin Layer

The magnetic carrier particle of the present disclosure includes a resin covering layer coating the surface of the magnetic core particle. The coating resin layer includes a coating resin and an inorganic fine particle A.

Examples of the coating resin that can be used include homopolymers of styrene and substituted styrenes such as poly-p-chlorostyrene and polyvinyltoluene; styrenic copolymer such as styrene-p-chlorostyrene copolymer, styrene-vinyltoluene copolymer, styrene-vinylnaphthalene copolymer, styrene-acrylic acid ester copolymer, and styrene-methacrylic acid ester copolymer; and styrenic copolymer resin, (meth)acrylic resin, silicone resin, polyester resin, styrene-acrylic resin, urethane resin, polyethylene, polyethylene terephthalate, polystyrene resin, polyamide resin, and polypropylene resin.

A resin having a reactive functional group may also be used as the coating resin. A known functional group such as a carboxy group, a hydroxy group, an epoxy group, an amino group, a vinyl group, a (meth)acryloyl group, an isocyanate group, a mercapto group, and an oxazoline group can be selected as the reactive functional group. Specifically, examples of the resin having a carboxy group include a resin obtained by polymerizing such monomers as acrylic acid, methacrylic acid, and itaconic acid, examples of the resin having a hydroxy group include resin obtained from 3-hydroxymethylacrylic acid, 2-hydroxyethylacrylic acid, 2-hydroxypropylacrylic acid, 2-hydroxypropylmethacrylic acid, and 2-hydroxybutylacrylic acid, examples of the resin having a vinyl group include resins obtained from allyl acrylate and allyl methacrylate, examples of the resin having an epoxy group include resins obtained from glycidylic acrylic acid, hydroxybutyl glycidyl ether acrylate, and β-(3,4-epoxycyclohexyl)ethyltrimethoxysilane, and examples of the resin having an amino group include acrylamide and methacrylamide.

### Inorganic Fine Particle A

The magnetic carrier particle of the present disclosure includes an inorganic fine particle A in the coating resin layer. Any known inorganic fine particle can be selected and used as the inorganic fine particle A as long as the work function thereof satisfies a particular relationship with the inorganic fine particle B. Examples thereof include a silica fine particle, a barium titanate fine particle, and a strontium titanate fine particle.

The inorganic fine particle A can be a silica fine particle from the viewpoint of suppressing the change in charge amount caused by changes in humidity. The silica fine particle may be any silica fine particle, and can be selected from known silica fine particles as long as the effects of the present disclosure are not impaired. Examples thereof include a fumed silica particle, a vaporized metal combustion silica particle, a sol-gel silica particle, a precipitated silica particle, and a colloidal silica particle. In particular, a wet-process silica particle produced by a wet process such as a sol-gel method and a precipitation method can be used since moisture is more easily adsorbed in a high-temperature, high-humidity environment and the effect of suppressing the change in charge amount caused by changes in humidity is enhanced.

The inorganic fine particle A can be hydrophobized by a surface treatment. Any known approach can be employed in the surface treatment. For example, an agent selected from a silane coupling agent having an alkyl group such as a methyl group, an ethyl group, or a propyl group, a titanate coupling agent, and an aluminate coupling agent can be used to obtain a silica particle having a desired hydrophobization rate by the surface treatment. In particular, a silane coupling agent can be used, and a hexamethyldisilazane treatment can be performed since the inorganic fine particle A easily and appropriately adsorbs moisture in a high-temperature, high-humidity environment.

The form of the inorganic fine particle A is not particularly limited, and may be spherical since wearing of the coating resin layer caused by interparticle contact of the magnetic carrier particle can be decreased. The number average particle diameter of the inorganic fine particle A can be 15 nm or more and 200 nm or less in order for the inorganic fine particle A to securely stick to the surface of the magnetic carrier particle and to be sufficiently exposed on the surface of the magnetic carrier particle.

### Toner Particle

The two-component developer of the present disclosure includes a toner particle produced by a known technique.

In general, a typical two-component developer contains, as a main component, a binder resin for a toner base, and optionally further contains a release agent, a coloring agent, a dispersing aid, and an inorganic particle.

### Binder Resin for Toner Base

Polymers described below are some of examples of binder resin for the toner base of the toner particle that can be used: homopolymers of styrenes and substituted styrenes such as poly-p-chlorostyrene and polyvinyltoluene; styrenic copolymer such as styrene-p-chlorostyrene copolymer, styrene-vinyltoluene copolymer, styrene-vinylnaphthalene copolymer, styrene-acrylic acid ester copolymer, and styrene-methacrylic acid ester copolymer; styrenic copolymer resin, polyester resin, and hybrid resin obtained by mixing or partly reacting polyester resin and vinyl resin; and polyvinyl chloride, phenolic resin, naturally modified phenolic resin, natural resin-modified maleic acid resin, acrylic resin, methacrylic resin, polyvinyl acetate, silicone resin, polyester resin, polyurethane, polyamide resin, furan resin, epoxy resin, xylene resin, polyethylene resin, and polypropylene resin. In particular, a polyester resin can be contained as a main component from the viewpoint of low-temperature fixability.

A polyhydric alcohol (dihydric or trihydric or higher alcohol) and a polycarboxylic acid (di- or tri- or higher carboxylic acid), an acid anhydride thereof, or a lower alkyl ester thereof are used as the monomers that form the polyester unit of a polyester resin. Here, in order to prepare a branched polymer to achieve “strain hardenability”, it is effective to perform partial crosslinking within the molecules of an amorphous resin, and, for this, a trivalent or higher functional compound can be used. Thus, raw material monomers for the polyester unit can include a tri- or higher carboxylic acid, an acid anhydride thereof, or a lower alkyl ester thereof, and/or a trihydric or higher alcohol.

Following polyhydric alcohol monomers can be used as the polyhydric alcohol monomer used in the polyester unit of the polyester resin.

Examples of the dihydric alcohol component include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and bisphenol represented by formula (A) and derivatives thereof:

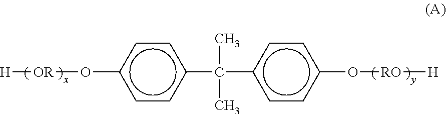

(In the formula, R represents ethylene or a propylene group, x and y each represent an integer of 0 or more, and the average value of x+y is 0 or more and 10 or less.); and diols represented by formula (B):

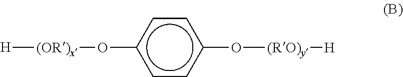

(In the formula, R′ represents

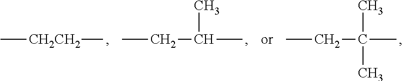

x′ and y′ each represent an integer of 0 or more, and the average value of x′+y′ is 0 or more and 10 or less.).

Examples of the trihydric or higher alcohol component include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of these, glycerol, trimethylolpropane, and pentaerythritol may be used, for example. These dihydric alcohols and trihydric or higher alcohols can be used alone or in combination.

Following polycarboxylic acid monomers can be used as the polycarboxylic acid monomer used in the polyester unit of the polyester resin.

Examples of the dicarboxylic acid component include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, anhydrides of these acids, and lower alkyl esters of these acids. Of these, maleic acid, fumaric acid, terephthalic acid, and n-dodecenylsuccinic acid may be used, for example.

Examples of the tri- or higher carboxylic acids, acid anhydrides thereof, and lower alkyl esters thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empol trimer acid, acid anhydrides thereof, and lower alkyl esters thereof. Of these, 1,2,4-benzenetricarboxylic acid, in other words, trimellitic acid, or a derivative thereof is inexpensive and easy to control the reaction, and thus may be used. These dicarboxylic acids and tri- or higher carboxylic acids can be used alone or in combination.

The method for producing the polyester unit is not particularly limited, and any know method may be employed. For example, the aforementioned alcohol monomer and carboxylic acid monomer may be simultaneously charged and then polymerized through esterification or transesterification and condensation reaction into a polyester resin. The polymerization temperature is not particularly limited and is, for example, in the range of 180° C. or higher and 290° C. or lower. For the polyester unit polymerization, for example, a polymerization catalyst such as a titanium catalyst, a tin catalyst, zinc acetate, antimony trioxide, or germanium dioxide can be used. In particular, the polyester unit of the binder resin for the toner base may be obtained by polymerization in the presence of a tin catalyst.

The polyester resin can have an acid value of 5 mgKOH/g or more and 20 mgKOH/g or less and a hydroxyl value of 20 mgKOH/g or more and 70 mgKOH/g or less from the viewpoint of fogging properties since the amount of moisture adsorption in a high-temperature, high-humidity environment can be suppressed and the non-electrostatic adhesive force can be decreased to a low level.

The binder resin for the toner base can be a mixture of a resin having a low molecular weight and a resin having a high molecular weight. The ratio of the content of the resin having a high molecular weight to the content of the resin having a low molecular weight in the binder resin for the toner base can be 40/60 or more and 85/15 or less on a mass basis from the viewpoints of low-temperature fixability and the hot offset resistance.

### Release Agent

The toner particle may contain a release agent to improve detachability from a member during heat fixing. Examples thereof are as follows: hydrocarbon wax such as low molecular weight polyethylene, low molecular weight polypropylene, alkylene copolymer, microcrystalline wax, paraffin wax, and Fischer-Tropsch wax; oxides of hydrocarbon wax such as polyethylene oxide wax or block copolymer thereof; wax containing a fatty acid ester as a main component, such as carnauba wax; and partly or entirely deoxidized fatty acid esters, such as deoxidized carnauba wax. Other examples are as follows: saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohols, behenyl alcohol, carnaubyl alcohol, ceryl alcohol, and melissyl alcohol; polyhydric alcohols such as sorbitol; esters of fatty acids, such as palmitic acid, stearic acid, behenic acid, and montanic acid, with alcohols such as stearyl alcohol, aralkyl alcohols, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bisoleic acid amide, hexamethylene bisoleic acid amide, N,N′-dioleyl adipic acid amide, and N,N′-dioleyl sebacic acid amide; aromatic bisamides such as m-xylene bisstearic acid amide and N,N′-distearyl isophthalic acid amide; aliphatic metal salts (commonly known as metal soaps) such as calcium stearate, calcium laurate, zinc stearate, and magnesium stearate; waxes obtained by grafting aliphatic hydrocarbon waxes with vinyl monomers such as styrene and acrylic acid; partial esters of fatty acids and polyhydric alcohols such as behenic acid monoglyceride; and methyl ester compounds having hydroxyl groups obtained by hydrogenating vegetable oils and fats.

Of these waxes, a hydrocarbon wax such as paraffin wax and Fischer-Tropsch wax or a fatty acid ester wax such as a carnauba wax can be used from the viewpoint of improving the low-temperature fixability and fixing detachability. In the present disclosure, a hydrocarbon wax may be used from the standpoint of further improving hot offset resistance. In the present disclosure, 3 parts by mass or more and 8 parts by mass or less of wax can be used per 100 parts by mass of the binder resin for the toner base.

Furthermore, in an endothermic curve in the heating cycle as measured with a differential scanning calorimetry (DSC) device, the peak temperature of the maximum endothermic peak of the wax can be 45° C. or higher and 140° C. or lower. When the peak temperature of the maximum endothermic peak of the wax is within this range, the storage stability and the hot offset resistance of the toner particle can both be achieved.

### Coloring Agent

The toner particle may contain a coloring agent. Examples of the coloring agent are as follows.

Examples of the black coloring agent include carbon black; and coloring agents adjusted to exhibit black by using yellow coloring agents, magenta coloring agents, and cyan coloring agents. A pigment may be used alone as the coloring agent; alternatively, from the viewpoint of the quality of a full color image, a dye and a pigment may be used in combination so that the definition is improved.

Examples of the pigment for magenta toners are as follows: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of the dye for magenta toners are as follows: C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; oil-soluble dyes such as C.I. Disperse Violet 1, and C.I. Basic Red 1, 2, 9, 12, 13, 14, 15, 17, 18, 22, 23, 24, 27, 29, 32, 34, 35, 36, 37, 38, 39, and 40; and basic dyes such as C.I. Basic Violet 1, 3, 7, 10, 14, 15, 21, 25, 26, 27, and 28.

Examples of the pigment for cyan toners are as follows: C.I. Pigment Blue 2, 3, 15:2, 15:3, 15:4, 16, and 17; C.I. Vat Blue 6; C.I. Acid Blue 45, and a copper phthalocyanine pigment having 1 to 5 phthalimidomethyl groups substituting the phthalocyanine frame.

An example of the dye for cyan toners is C.I. Solvent Blue 70.

Examples of the pigment for yellow toners are as follows: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

An example of the dye for yellow toners is C.I. Solvent Yellow 162.

These coloring agents can be used alone or as a mixture, and can be used in a solid solution state. The coloring agent is selected from the standpoints of hue angle, saturation, lightness, lightfastness, OHP transparency, and dispersibility in toners.

The amount of the coloring agent contained relative to the total amount of the resin component can be 0.1 parts by mass or more and 30.0 parts by mass or less.

### Dispersing Aid

The toner particle can contain a dispersing aid to disperse a release agent in the resin. The dispersing aid may be any known dispersing aid; however, when hydrocarbon wax is contained as the release agent, a polymer having a structure obtained by the reaction between a vinyl resin component and a hydrocarbon compound can be contained in order to disperse the wax in the resin. In particular, a graft polymer in which a polyolefin is grafted with a vinyl monomer can be contained.

When a polymer is contained in the dispersing aid, compatibility between the wax and the resin is enhanced, and issues such as charging failure caused by poorly dispersed wax and contamination of the members are less likely to arise. The amount of the release agent contained relative to 100 parts by mass of the binder resin for the toner base can be 1.0 part by mass or more and 15 parts by mass or less. When the amount of the dispersing aid contained is within this range, the dispersed state of the wax in the amorphous resin tends to be more homogeneous. The polyolefin may be any polymer or copolymer of an unsaturated hydrocarbon, and various polyolefins can be used. In particular, polyethylenes and polypropylenes can be used. Two or more these can be used.

Examples of the monomer having a vinyl group are as follows:
styrenic units such as styrenes and derivatives thereof, e.g., styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene;
N-atom-containing vinyl units such as amino group-containing a-methylene aliphatic monocarboxylic acid esters, e.g., dimethylaminoethyl methacrylate and diethylaminoethyl methacrylate; and derivatives of acrylic acid and methacrylic acid, e.g., acrylonitrile, methacrylonitrile, and acrylamide;
carboxy group-containing vinyl units such as unsaturated dibasic acids i.e., maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenylsuccinic anhydride; half esters of unsaturated dibasic acids such as methyl maleate half ester, ethyl maleate half ester, butyl maleate half ester, methyl citraconate half ester, ethyl citraconate half ester, butyl citraconate half ester, methyl itaconate half ester, methyl alkenylsuccate half ester, methyl fumarate half ester, and methyl mesaconate half ester; unsaturated dibasic acid esters such as dimethyl maleic acid and dimethyl fumaric acid; α,β-unsaturated acids such as acrylic acid, methacrylic acid, crotonic acid, and cinnamic acid; α,β-unsaturated acid anhydrides such as crotonic anhydride and cinnamic anhydride and anhydrides between the aforementioned α,β-unsaturated acids and lower fatty acids; alkenylmalonic acid, alkenylglutaric acid, alkenyladipic acid, acid anhydrides thereof, and monoester thereof;
hydroxy group-containing vinyl units such as acrylic or methacrylic acid esters, e.g., 2-hydroxyethyl acrylate, 2-hydroxyethyl methacrylate, and 2-hydroxypropyl methacrylate, 4-(1-hydroxy-1-methylbutyl) styrene, and 4-(1-hydroxy-1-methylhexyl) styrene;
ester units composed of acrylic acid esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; and
ester units composed of methacrylic acid esters such as α-methylene aliphatic monocarboxylic acid esters, e.g., cyclohexyl methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate. Two or more these may be used.

The aforementioned dispersing aids can be obtained by known methods, such as the reaction between these polymers and the reaction between a monomer of one polymer and another polymer.

### External Additive

As an external additive, the aforementioned inorganic fine particle B may be added to the toner particle of the present disclosure.

The fixing ratio of the inorganic fine particle B to the toner particle as measured by a water washing method can be 5% to 85% from the viewpoint of obtaining a two-component developer containing the inorganic fine particle B. The fixing ratio of the inorganic fine particle B to the toner particle can be 10% to 60% or 20% to 40%. The fixing ratio of the inorganic fine particle B to the toner particle can be controlled by the number average particle diameter of the inorganic fine particle B and the surface treatment method of the inorganic fine particle B, the amount of the inorganic fine particle B added to the toner particle, the external addition conditions, etc.

An external additive other than the inorganic fine particle B may be added to the toner particle to mainly enhance flowability and chargeability.

A spacer particle that suppresses blocking of the toner particle can be a silica particle that has a number distribution-based maximum peak particle diameter of 50 nm or more and 200 nm or less. The silica particle may have a diameter of 80 nm or more and 150 nm or less from the viewpoint of suppressing detachment from the toner particle while functioning as a spacer particle.

In order to improve the flowability of the toner particle, an inorganic fine particle having a number distribution-based maximum peak particle diameter of 20 nm or more and 50 nm or less can be contained, and this inorganic fine particle may be used in combination with the aforementioned spacer particle.

Furthermore, other external additives may be added to the toner particle to improve flowability and transferability. The external additive externally added to the toner particle surface can contain an inorganic fine particle such as titanium oxide, alumina, strontium titanate, and barium titanate, and two or more external additives may be used in combination.

The total amount of the external additives added to the toner particle per 100 parts by mass of the toner particle can be 0.3 parts by mass or more and 5.0 parts by mass or less or can be 0.8 parts by mass or more and 4.0 parts by mass or less. In particular, the amount of the silica particle having a number distribution-based maximum peak particle diameter of 50 nm or more and 200 nm or less contained therein is 0.1 parts by mass or more and 2.5 parts by mass or less or can be 0.5 parts by mass or more and 2.0 parts by mass or less. Within this range, the effect as the spacer particle becomes more prominent.

In addition, the surface of the inorganic fine particle used as an external additive can be hydrophobized. Hydrophobizing can be performed by using a coupling agent such as various titanium coupling agents and silane coupling agents, a fatty acid or a metal salt thereof, silicone oil, or any combination of these.

Hydrophobizing can be performed by adding 1 mass % or more and 30 mass % or less (or 3 mass % or more and 7 mass % or less) of a hydrophobic treatment agent to a particle to be hydrophobized so as to coat the particle to be hydrophobized with the hydrophobic treatment agent.

The degree of hydrophobization of the hydrophobized external additive is not particularly limited, and, for example, the hydrophobization rate of the external additive can be 40% or more and 98% or less. The hydrophobization rate indicates the wettability of a sample to methanol, and is an indicator of the hydrophobicity.

### Methods for Producing Toner Particle and Toner

The method for producing the toner particle is not particularly limited, and a known method such as a pulverization method, a suspension polymerization method, a dissolution suspension method, an emulsion aggregation method, or a dispersion polymerization method can be used. Of these, from the viewpoint of controlling the wax on the surface of the toner particle, the pulverization method can be employed. In other words, the toner particle may be a pulverized toner particle.

The procedure for producing a toner particle by a pulverization method will now be described.

In a raw material mixing step, materials constituting the toner particle, that is, for example, a binder resin, a release agent, a coloring agent, a crystalline polyester, and, if necessary, other components such as a charge control agent, are weighed into particular amounts, blended, and mixed. Examples of the mixing device include Double Cone Mixer (produced by NISHIMURA MACHINE WORKS CO., LTD.), V-type mixer (produced by NISHIMURA MACHINE WORKS CO., LTD.), Drum mixer (produced by EISHIN Co., Ltd.), Super Mixer (produced by KAWATA MFG. CO., LTD.), Henschel mixer (produced by NIPPON COKE & ENGINEERING. CO., LTD.), Nauta mixer (produced by Hosokawa Micron Corporation), and Mechano Hybrid (produced by NIPPON COKE & ENGINEERING. CO., LTD.).

Next, the mixed materials are melt-kneaded to disperse the wax and other components in the binder resin. In this melt kneading step, a batch-type kneader such as a pressure kneader and a Banbury mixer or a continuous kneader can be used; however, the mainstream kneader is a single-screw or twin-screw extruder which offers an advantage of continuous production. Examples of such an extruder include KTK-type twin-screw extruder (produced by KOBE STEEL, LTD.), TEM-type twin-screw extruder (produced by TOSHIBA MACHINE CO., LTD.), PCM kneader (produced by Ikegai Ironworks Corp), twin-screw extruder (produced by manufactured by KCK Corporation), Co-kneader (produced by Buss AG), and KNEADEX (produced by NIPPON COKE & ENGINEERING. CO., LTD.).

Furthermore, the resin composition obtained by melt kneading may be rolled with a twin roll or the like and cooled with water or the like in a cooling step.

Then the cooled resin composition is pulverized to a desired particle diameter in a pulverizing step. In the pulverizing step, for example, the resin composition is roughly pulverized with a pulverizer such as a crusher, a hammer mill, or a feather mill, and then finely pulverized by KRYPTRON system (produced by Kawasaki Heavy Industries, Ltd.), Super Rotor (produced by Nisshin Engineering Inc.), Turbo-mill (produced by TURBO KOGYO CO., LTD.), or an air-jet-type fine pulverizer.

Subsequently, if necessary, the finely pulverized composition is classified by using a classifier or a sieving machine such as inertial classification system Elbow-jet (produced by Nittetsu Mining Co., Ltd.), centrifugal classification system Turboplex (produced by Hosokawa Micron Corporation), a TSP separator (produced by Hosokawa Micron Corporation), or FACULTY (produced by Hosokawa Micron Corporation).

Then an inorganic fine particle such as a silica fine particle is externally added to the surface of the toner particle to obtain a toner. An example of the method for externally adding an inorganic fine particle is a method that involves blending predetermined amounts of various types of known inorganic fine particles with the classified toner, and stirring and mixing the resulting mixture by using a mixing device as an external addition machine, such as Double Cone Mixer (produced by NISHIMURA MACHINE WORKS CO., LTD.), V-type mixer (produced by NISHIMURA MACHINE WORKS CO., LTD.), Drum mixer (produced by EISHIN Co., Ltd.), Super Mixer (produced by KAWATA MFG. CO., LTD.), Henschel mixer (produced by NIPPON COKE & ENGINEERING. CO., LTD.), Nauta mixer (produced by Hosokawa Micron Corporation), Mechano Hybrid (produced by NIPPON COKE & ENGINEERING. CO., LTD.), or Nobilta (produced by Hosokawa Micron Corporation).

### Method for Producing Magnetic Carrier Particle

The method for producing a magnetic carrier particle differs depending on the type of the particle. In the description below, a process of producing a porous magnetic particle is described in detail as one example.

### Method for Producing Magnetic Core Particle

### Step 1: Weighing and Mixing Step

First, raw materials for a ferrite are weighed and mixed.

A ferrite is a sintered material represented by the following general formula:

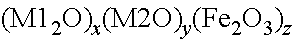

In the formula, M1 represents a monovalent metal, M2 represents a divalent metal, and when x+y+z=1.0, x and y are 0≤(x, y)≤0.8, and z is 0.2<z<1.0.

M1 and M2 in the formula can each be at least one metal atom selected from the group consisting of Li, Fe, Mn, Mg, Sr, Cu, Zn, and Ca. Alternatively, for example, Ni, Co, Ba, Y, V, Bi, In, Ta, Zr, B, Mo, Na, Sn, Ti, Cr, Al, Si, and rare earth elements can also be used.

Examples of the raw materials for the ferrite include metal particles of the aforementioned metal elements, oxides thereof, hydroxides thereof, oxalates thereof, and carbonates thereof. Examples of the device used for mixing are as follows: a ball mill, a planetary mill, a jet mill, and a vibrating mill. In particular, a ball mill can be used from the viewpoint of mixing properties. Specifically, the weighed ferrite raw materials and balls are placed in a ball mill, and the resulting mixture is pulverized and mixed for, for example, 0.1 hours or more and 20.0 hours or less.

### Step 2: Calcining Step

The pulverized and mixed ferrite raw materials are calcined into a ferrite in air or a nitrogen atmosphere at, for example, a calcining temperature in the range of 700° C. or higher and 1200° C. or lower for, for example, 0.5 hours or more and 5.0 hours or less. Examples of the furnace used for calcining are as follows: a burner-type combustion furnace, a rotary-type combustion furnace, and an electric furnace.

### Step 3: Pulverizing Step

The calcined ferrite prepared in step 2 is pulverized with a pulverizer. The pulverizer may be any pulverizer as long as the desired particle diameter is obtained. Examples thereof are as follows: a crusher, a hammer mill, a ball mill, a bead mill, a planetary mill, and a jet mill. To pulverize the pulverized ferrite into a desired particle diameter, for example, raw materials and diameters of beads and balls used in the ball mill or the bead mill, and the operation time can be controlled. Specifically, in order to decrease the particle diameter of the calcined ferrite slurry, balls with large specific gravities may be used or the pulverization time may be extended. In order to broaden the particle size distribution of the calcined ferrite, balls or beads having large specific gravities may be used to shorten the pulverization time. Furthermore, a calcined ferrite with a broad distribution can be obtained by mixing multiple types of calcined ferrites having different particle diameters. A wet-system ball or bead mill exhibits higher pulverization efficiency than a dry-system mill since the pulverized materials do not fling up inside the mill. Thus, a wet system can be used rather than a dry system.

### Step 4: Particle Forming Step

To the pulverized calcined ferrite, water, a binder, and, if necessary, a pore adjusting agent are added. Examples of the pore adjusting agent include a foaming agent and a resin fine particle. Examples of the foaming agent include sodium bicarbonate, potassium bicarbonate, lithium bicarbonate, ammonium bicarbonate, sodium carbonate, potassium carbonate, lithium carbonate, and ammonium carbonate.

Polyvinyl alcohol is used as the binder, for example.

Examples of the resin fine particle include fine particles of polyester, polystyrene, styrenic copolymers such as styrene-vinyltoluene copolymer, styrene-vinylnaphthalene copolymer, styrene-acrylic acid ester copolymer, styrene-methacrylic acid ester copolymer, styrene-a-methyl chloromethacrylate copolymer, styrene-acrylonitrile copolymer, styrene-vinyl methyl ketone copolymer, styrene-butadiene copolymer, styrene-isoprene copolymer, and styrene-acrylonitrile-indene copolymer; polyvinyl chloride, phenolic resin, modified phenolic resin, maleic resin, acrylic resin, methacrylic resin, polyvinyl acetate, and silicone resin; a polyester resin having, as a structural unit, a monomer selected from aliphatic polyhydric alcohols, aliphatic dicarboxylic acids, aromatic dicarboxylic acids, aromatic dialcohols, and diphenols; and a polyurethane resin, a polyamide resin, polyvinyl butyral, a terpene resin, a coumarone-indene resin, a petroleum resin, and a hybrid resin having a polyester unit and a vinyl polymer unit.

When pulverization is performed by a wet system in step 3, the binder and, if necessary, the pore adjusting agent can be added while considering water contained in the ferrite slurry.

The obtained ferrite slurry is dried and formed into particles by using a spray drying machine in a heated atmosphere at 100° C. or higher and 200° C. or lower, for example. The spray drying machine may be any as long as a porous magnetic particle having the desired particle diameter is obtained. An example thereof is a spray dryer.

### Step 5: Firing Step

Next, the produced particle is fired at, for example, 800° C. or higher and 1400° C. or lower for, for example, 1 hour or more and 24 hours or less. By increasing the firing temperature and extending the firing time, firing of the porous magnetic core particle progresses, and, as a result, the pore diameter decreases, and so does the number of pores.

### Step 6: Selection Step

After the particle fired as described above is disintegrated, coarse particles and fine particles may be removed by classification or sieving through a screen as necessary.

### Step 7: Filling Step

The method for filling the pores in the porous magnetic core particle with a resin is not particularly limited, and an example thereof is a method that involves impregnating the porous magnetic core particle with a resin solution by such a method as a dipping method, a spraying method, a brushing method, or a flow bed coating method, and then evaporating the solvent. Another example is a method that involves diluting a resin with a solvent and adding the diluted resin to pores in a porous magnetic core particle.

The solvent used here may be any solvent that can dissolve the resin. When the resin is soluble in an organic solvent, examples of the organic solvent include toluene, xylene, cellosolve butyl acetate, methyl ethyl ketone, methyl isobutyl ketone, and methanol. When the resin is water-soluble or of an emulsion type, water may be used as the solvent.

The amount of the resin solid component in the resin solution can be 1 mass % or more and 50 mass % or less or can be 1 mass % or more and 30 mass % or less. At 50 mass % or less, the viscosity is not excessively high, and the resin solution easily and evenly penetrates the pores in the porous magnetic core particle. Meanwhile, at 1 mass % or more, the amount of the resin is appropriate, and the adhesive force of the resin to the porous magnetic core particle is improved. The method for coating the surface of the magnetic core particle with the resin thereafter is not particularly limited, and examples of the coating method include a dipping method, a spraying method, a brushing method, a dry method, and a flow bed coating method.

### Method for Forming Coating of Coating Resin

The method for coating the surface of the magnetic core particle with the coating resin is not particularly limited and any known method may be employed. One example of the method is a so-called dipping method that involves evaporating the solvent while stirring the magnetic core particle and the coating resin solution so as to coat the surface of the magnetic core particle with the coating resin. Specific examples of the device used here include universal mixer stirrer (produced by Fuji Paudal Co., Ltd.), Nauta mixer (produced by Hosokawa Micron Corporation), and vacuum deaeration kneader. Another method involves spraying a coating resin solution from a spray nozzle while forming a fluidized bed to coat the surface of the magnetic core particle with the coating resin. Specific examples of the device used here include the SPIRA COTA (produced by Okada Seiko Co., Ltd.) and SPIR-A-FLOW (produced by FREUND CORPORATION). Another example is a method that involves coating a magnetic carrier core with a coating resin in a particle state by a dry process. A specific example of the method is a processing method that uses such a device as Hybridizer (produced by Nara Machinery), Mechano Fusion (produced by Hosokawa Micron Corporation), High Flex Gral (produced by Fukae Powtec Corporation), or Theta Composer (produced by Tokuju Corporation).

### Method for Producing Two-Component Developer

The two-component developer of the present disclosure includes a toner particle, a magnetic carrier particle, and an inorganic fine particle B. The method for producing the two-component developer is not particularly limited, and examples thereof include a production method that involves mixing the toner particle, the magnetic carrier particle, and the inorganic fine particle B, and a production method that involves obtaining a toner by mixing the toner particle, an external additive, and an inorganic fine particle B and then mixing the toner and a magnetic carrier particle.

A common mixing device can be used in mixing. Examples thereof include Double Cone Mixer (produced by NISHIMURA MACHINE WORKS CO., LTD.), V-type mixer (produced by NISHIMURA MACHINE WORKS CO., LTD.), Drum mixer (produced by EISHIN Co., Ltd.), Super Mixer (produced by KAWATA MFG. CO., LTD.), Henschel mixer (produced by NIPPON COKE & ENGINEERING. CO., LTD.), and Nauta mixer (produced by Hosokawa Micron Corporation). By using these devices, the toner and the carrier are homogeneously mixed, and a developer for replenishment and the developer inside the developing device can be thoroughly mixed.

When mixing the toner with a magnetic carrier particle, the carrier mixing ratio in terms of the toner concentration in the two-component developer can be 2 mass % or more and 15 mass % or less or can be 4 mass % or more and 13 mass % or less. Within this range, fogging and toner scattering can be satisfactorily suppressed.

Alternatively, the two-component developer can be produced by the following production method. A method for producing a two-component developer, the method including: a step of obtaining a toner particle mixture by mixing a toner particle and an external additive other than an inorganic fine particle B; a step of obtaining a toner by mixing the toner particle mixture and the inorganic fine particle B; and a step of obtaining a two-component developer by mixing the toner and a magnetic carrier particle.

Method for Recovering Inorganic Fine Particle B from Two-Component Developer (Water Washing Method)

The inorganic fine particle B is recovered from the two-component developer by the following method: (i) A mixture containing the toner particle and the inorganic fine particle B is recovered from the two-component developer by using a washing solution containing a surfactant and an organic builder. (ii) The inorganic fine particle B is recovered from the mixture recovered in (i) by a density gradient centrifugation method. In the description below, (i) and (ii) above are described in detail.

(i) Into a 100 mL plastic cup, 1 g of Contaminon N (produced by Wako Pure Chemical Corporation, a 10 mass % aqueous solution of a pH 7 neutral detergent for precision measuring instruments, containing a nonionic surfactant, an anionic surfactant, and an organic builder) and 50 g of deionized water are placed to prepare a washing solution. To the aforementioned plastic cup, 10 g of the two-component developer is placed and mixed with the washing solution. Then a neodymium magnet is placed on the bottom of the plastic cup, and the supernatant is recovered.

Then 1 g of Contaminon N and 50 g of deionized water are placed in the aforementioned plastic cup, a neodymium magnet is placed on the bottom of the plastic cup, and the supernatant is recovered. This operation is repeatedly performed three times, the obtained supernatants are filtered to remove the liquid component, and the mixture containing the toner particle and the inorganic fine particle B is recovered. This recovery operation is repeated until a total of 1 g of the mixture containing the toner particle and the inorganic fine particle B is obtained.

(ii) Into 100 mL of deionized water, 160 g of sucrose (produced by KISHIDA CHEMICAL CO., LTD.) is added and dissolved over hot water to prepare a sucrose solution. Then 31 g of the sucrose solution and 6 mL of Contaminon N (produced by Wako Pure Chemical Corporation, a 10 mass % aqueous solution of a pH 7 neutral detergent for precision measuring instruments, containing a nonionic surfactant, an anionic surfactant, and an organic builder) are mixed to prepare a dispersion. To this dispersion, 1 g of the mixture containing the toner particle and the inorganic fine particle B obtained above is added, and the resulting mixture is shaken with a shaker (NR-10 produced by TAITEC CORPORATION) for 5 minutes under the condition of 350 reciprocal motions per minute. The dispersion after shaking is re-placed into a centrifugal separation tube and is centrifuged with a centrifuge under the conditions of 3500 rpm for 30 minutes.

In the tube after the centrifugation, the toner particle is present in the upper-most layer, and a fine particle mixture containing the inorganic fine particle B is present on the aqueous solution side in the lower layer. The aqueous solution in the lower layer is taken and centrifuged to separate a fine particle mixture containing a dispersion and an inorganic fine particle B. If necessary, the centrifugal operation is repeated to achieve sufficient separation, and the resulting dispersion is dried to recover the inorganic fine particle B. From the mass of the obtained inorganic fine particle B, the recovery amount GB (parts by mass) of the inorganic fine particle B per 100 parts by mass of the two-component developer is calculated.

Method for Separating Magnetic Carrier from Two-Component Developer

Into a 100 mL plastic cup, 1 g of Contaminon N (produced by Wako Pure Chemical Corporation, a 10 mass % aqueous solution of a pH 7 neutral detergent for precision measuring instruments, containing a nonionic surfactant, an anionic surfactant, and an organic builder) and 50 g of deionized water are placed to prepare a washing solution. To the aforementioned plastic cup, 10 g of the two-component developer is placed and mixed with the washing solution. Then a neodymium magnet is placed on the bottom of the plastic cup, and the supernatant is removed.

Then 1 g of Contaminon N and 50 g of deionized water are placed in the aforementioned plastic cup, a neodymium magnet is placed on the bottom of the plastic cup, and the supernatant is removed. This operation is repeatedly performed three times. Then the solid component in the plastic cup is dried at 50° C. to obtain a magnetic carrier. From the mass of the obtained magnetic carrier, the content GC (parts by mass) of the magnetic carrier per 100 parts by mass of the two-component developer is calculated.

The recovery amount XB (parts by mass) per 100 parts by mass of the magnetic carrier particle specified by the present disclosure is calculated from the following equation by using GB and GC described above.

$$recovery amount XB ( parts by mass ) per 100 parts by mass of \\ \\ \\ magnetic carrier particle = 100 \times GB / GC$$

Method for Separating Magnetic Core Particle from Carrier Particle

To 10 g of the carrier particle, 100 mL of methyl isobutyl ketone is added, and the resulting mixture is ultrasonically washed at an output of 60 kHz for 15 minutes. After only the solid component is separated by using a paper filter for which the standard for retained particles is 7 μm, 100 mL of toluene is added, and the resulting mixture is ultrasonically washed and filtered in the same manner twice. The obtained solid was dried by using a vacuum dryer to obtain a magnetic core particle.

Method for Separating Inorganic Fine Particle a from Carrier Particle

To 10 g of the carrier particle, 10 mL of methyl isobutyl ketone is added, and the resulting mixture is ultrasonically washed at an output of 60 kHz for 15 minutes. After the liquid phase is recovered by decantation, 10 mL of toluene is added, and the same ultrasonic washing and recovery of the liquid phase are repeated twice. After all of the recovered liquid phases are combined, a magnetic material (magnetic core particle) is removed from the liquid phase by using a permanent magnet.

The obtained liquid phase is placed in a centrifuge and rotated at 15,000 rpm for 2 hours to separate the solid component. To the obtained solid component, 20 mL of tetrahydrofuran is added, and the resulting mixture is exposed to ultrasonic waves to dissolve or disperse all of the solid component in the liquid. The obtained liquid is placed in a centrifuge and rotated at 15,000 rpm for 2 hours to separate the solid component, and the solid component is vacuum-dried with a vacuum dryer at 120° C. for 24 hours. To the obtained solid component, tetrahydrofuran is added, and the resulting mixture is centrifuged and dried twice to obtain an inorganic fine particle A.

Method for Separating Coating Resin from Carrier Particle

To 10 g of the carrier particle, 10 mL of methyl isobutyl ketone is added, and the resulting mixture is ultrasonically washed at an output of 60 kHz for 15 minutes. After the liquid phase is recovered by decantation, 10 mL of toluene is added, and the same ultrasonic washing and recovery of the liquid phase are repeated twice. After all of the recovered liquid phases are combined, a magnetic material (magnetic core particle) is removed from the liquid phase by using a permanent magnet.

The obtained liquid phase is placed in a centrifuge and rotated at 15,000 rpm for 2 hours to separate the solid component. The solvent in the obtained liquid phase is concentrated by reduced-pressure distillation until the volume of the solution is about 1 mL. Thereto, 15 mL of n-hexane is added, and the solid component is deposited and then filtered through a paper filter for which the standard for retained particles is 1 μm. Washing with 15 mL of n-hexane and filtration are repeated three times. The obtained solid component is dried with a vacuum dryer to obtain a coating resin.

### Measurement of Fixing Ratio of Inorganic Fine Particle B to Toner Particle

The fixing ratio of the inorganic fine particle B to the toner particle is measured as follows. First, the quantity of the inorganic fine particle B contained in 1 g of the toner is determined. Next, the quantity of the inorganic fine particle B recovered from 1 g of the toner as a result of the following separation treatment is determined. The fixing ratio is calculated from the following equation.

$$Fixing ratio ( \% ) = ( ( amount of inorganic fine particle B in 1 g of toner ) - ( amount of inorganic fine particle B recovered \\ from 1 g of toner as a result of seperation treatment ) ) / \\ ( amount of inorganic fine particle B in 1 g of toner ) \times 100$$

To 100 mL of deionized water, 160 g of sucrose (produced by KISHIDA CHEMICAL CO., LTD.) is added and dissolved over hot water to prepare a sucrose solution. Then 31 g of the sucrose solution, and 6 mL of Contaminon N (produced by Wako Pure Chemical Corporation, a 10 mass % aqueous solution of a pH 7 neutral detergent for precision measuring instruments, containing a nonionic surfactant, an anionic surfactant, and an organic builder) are mixed to prepare a dispersion. To this dispersion, 1 g of a toner is added, and the resulting mixture is shaken with a shaker (NR-10 produced by TAITEC CORPORATION) for 5 minutes under the condition of 350 reciprocal motions per minute. The dispersion after shaking is re-placed into a centrifugal separation tube and is centrifuged with a centrifuge under the conditions of 3500 rpm for 30 minutes.

In the tube after the centrifugation, the toner particle is present in the upper-most layer, and a fine particle mixture containing the inorganic fine particle B is present on the aqueous solution side in the lower layer. The aqueous solution in the lower layer is taken and centrifuged to separate a fine particle mixture containing a dispersion and an inorganic fine particle B. If necessary, centrifugation is repeated to achieve sufficient separation, and the resulting dispersion is dried to recover the inorganic fine particle B. The mass of the obtained inorganic fine particle B is assumed to be the amount of the inorganic fine particle B recovered from 1 g of the toner.

### Method for Measuring Coverage of Surface of Magnetic Carrier Particle by Inorganic Fine Particle A

The coverage XA in the present disclosure is measured by analyzing a secondary electron image taken with a scanning electron microscope.

The secondary electron image is acquired by scanning electron microscope SU8220 (produced by Hitachi High-Tech Corporation). Specifically, one layer of the magnetic carrier particle is fixed with a carbon tape onto a sample stage for electron microscope observation, flashed, and observed. The observation conditions are as follows.

$$Signal Name = SE ( U )$$

$$Accelerating Voltage = 800 V$$

$$Working Distance = 8000 µm$$

$$Emission Current = 10000 nA$$

$$Lens Mode = High$$

$$Condenser 1 = 5000$$

$$Scan Speed = slow 3$$

$$Color Mode = Gray scale$$

$$Data Size = 1280 \times 960$$

$$Magnification = 25000$$

When measuring the secondary electron image, the control software is set to a contrast of 60 and a brightness of −15, and the image is acquired such that a resin layer as flat as possible is captured at the center portion and the contrast derived from the surface profile is minimized. In the view area observed here, it is possible to distinguish between image regions respectively indicating the resin layer portion and the inorganic fine particle A portion by using EDX observation in combination.

By analyzing the obtained secondary electron image, the coverage of the surface of the magnetic carrier particle by the inorganic fine particle A exposed on the surface of the surface of the magnetic carrier particle is calculated. Specifically, the image is binarized by using programming language “Python” and extended libraries “OpenCV” and “NumPy” to count the number of pixels where the brightness value is 255. The detailed procedure is as follows.

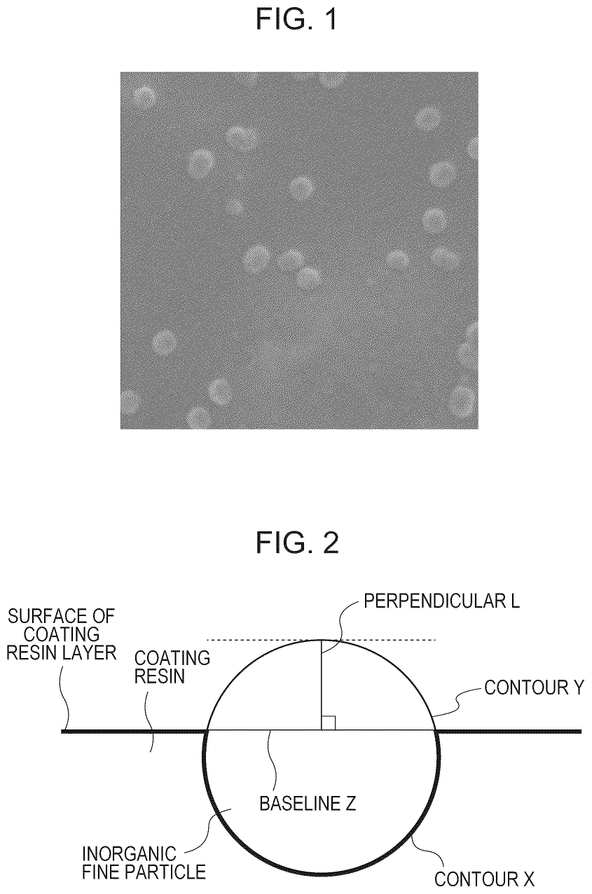

First, a 400×400 pixel region is trimmed from the image. In doing so, observation with naked eye of an observer is used to select an image region where only the coating resin and the silica particle are included and where the surface is as flat as is feasibly possible ant the contrast derived from the surface irregularities is small. One example of such an image is illustrated in FIG. 1. Next, a median blur process expressed by condition expression (1) is run to remove noise. Here, “img” in condition expression (1) is a variable indicating the input image.

$$cv 2. medianBlur ( img , ksize = 9 ) \qquad condition expression ( 1 )$$

In addition, the image after the noise removal is binarized into an image that includes only pixels having a brightness value of 0 and pixels having a brightness value of 255. The conditions expressed by condition expression (2) are used for this process. Here, “img” in condition expression (2) is a variable indicating the image after the median blur process.

$$cv 2. threshold ( img , 0 , 255 , cv 2. THRESH\_OTSU ) \qquad condition expression ( 2 )$$

From the binarized image, the number of pixels having a brightness value of 255 is counted, and the result is divided by 160,000, which is the number of pixels included in the 400×400 pixel region, to calculate the coverage by the silica particle on the surface of the carrier particle. The conditions used for this are expressed by condition expression (3). Here, “img” in condition expression (3) is a variable indicating the image after the binarization.

$$( img / 255 ) . sum ( ) / 160000 * 100 \qquad condition expression ( 3 )$$

This operation is performed on 50 particles, and the arithmetic average of 30 values excluding 1st to 10th values and 41st to 50th values in the ascending order of the coverage is assumed to be the coverage XA (area %) of the surface of the magnetic carrier particle by the inorganic fine particle A.

### Method for Measuring Average of Height of Protrusion of Inorganic Fine Particle a Exposed on Surface of Magnetic Carrier Particle

A cross section of the magnetic carrier particle is observed with a transmission electron microscope (TEM), and the average of the height of the protrusion of the inorganic fine particle A exposed on the surface of the magnetic carrier particle is measured.

First, the magnetic carrier particle is subjected to ion milling with an argon ion milling apparatus (trade name: E-3500 produced by Hitachi High-Tech Corporation) to acquire a cross section of the magnetic carrier particle. The ion milling measurement conditions are as follows.
Beam diameter: 400 μm (half-value width)
Ion gun acceleration voltage: 5 kV
Ion gun discharge voltage: 4 kV
Ion gun discharge current: 463 μA

Next, the cross section of the magnetic carrier particle is observed with a transmission electron microscope (trade name: JEM-2800 produced by JEOL Ltd.) (TEM-EDX) at a magnification of 50,000 in a view area where the outermost surface of the magnetic carrier particle can be observed. In doing so, it is possible to distinguish between the cross section portion of the coating resin layer and the cross section portion of the inorganic fine particle A on the outermost surface of the magnetic carrier particle within the view area by using EDX observation in combination. From the image of the observed cross section of the inorganic fine particle A, a cross sectional area of the inorganic fine particle A is determined, and the diameter (circle-equivalent diameter) of a circle having the same area as the cross sectional area is determined. Images of cross sections of the inorganic fine particle A having a circle-equivalent diameter within ±10% of the number average particle diameter of the inorganic fine particle A separated from the magnetic carrier particle are used in the measurement.

FIG. 2 is a schematic diagram illustrating method for measuring the average value of the height of the protrusion of the inorganic fine particle A exposed on the surface of the magnetic carrier particle. In the observed image, of the contour of the inorganic fine particle A, a part of the contour of the inorganic fine particle A in contact with the coating resin layer is defined as a contour X, and the rest other than the contour X is defined as a contour Y. An inorganic fine particle A that has both a contour X and a contour Y is deemed as an inorganic fine particle A exposed on the surface of the magnetic carrier particle, and is used as the measurement target. The endpoints of the contour X of the inorganic fine particle A used as the measurement target are connected with a straight line to define a baseline Z. Of the perpendiculars connecting the baseline Z and the contour Y, the longest perpendicular is defined as a perpendicular L, and the length of the perpendicular L is measured.

The perpendiculars L of 100 inorganic fine particles A exposed on the surface of the magnetic carrier particle are measured by the aforementioned procedure. The arithmetic average of one hundred observed measured values is assumed to be the average value HA (nm) of the height of the protrusion.

### Measurement of Number Average Particle Diameter of Primary Particles of Inorganic Fine Particle

First, into 95.0 g RO water, 5.0 g of Triton-X100 (produced by KISHIDA CHEMICAL CO., LTD.) is placed to prepare a 5% aqueous solution of Triton-X100 (hereinafter referred to as a 5% Triton solution). To 10 mg of the dried inorganic fine particle, 0.2 g of the 5% Triton solution and 19.8 g of RO water are added to prepare a solution. Then the leading edge of a probe of an ultrasonic disperser is dipped in this solution, and ultrasonic dispersing is performed at an output or 20 W for 15 minutes to obtain a dispersion. Next, this dispersion is used to measure the number average particle diameter (nm) of primary particles of the inorganic fine particles with a dynamic light scattering (DLS) particle diameter distribution meter (trade name: NANOTRAC 150 produced by MicrotracBEL Corp.).
Mode: transmission
Particle condition: spherical
Particle refractive index: 1.45
Particle density: 1.30
Dispersion medium refractive index: 1.33 (water)
Measurement time: 120 seconds

### Method for Measuring Volume Distribution-Based 50% Diameter (D50) of Magnetic Carrier Particle

The particle size distribution is measured with a laser diffraction/scattering particle size distribution meter, “Microtrac MT3300EX” (produced by Nikkiso Co., Ltd.).

The volume distribution-based 50% diameters (D50) of the magnetic carrier particle and the magnetic core particle are measured by attaching a sample feeder, “One-Shot Dry-type sample conditioner Turbotrac” (produced by Nikkiso Co., Ltd.), for dry-system measurement. The feed conditions of Turbotrac are that a dust collector is used as a vacuum source at an air flow of about 33 L/see and a pressure of about 17 kPa. Control is automatically executed by bundled software (ver. 10.3.3-202D), and the same software is used for analysis. The measurement conditions are as follows.
Set Zero time: 10 seconds
Measurement time: 10 seconds
Number of runs: 1
Particle refractive index: 1.81
Particle shape: aspherical
Measurement upper limit: 1408 μm
Measurement lower limit: 0.243 μm
Measurement environment: temperature of 23° C., humidity of 50%

### Measurement of Compression Energy of Inorganic Fine Particle

The compression energy of the inorganic fine particle is measured by using a powder rheometer (FT4 produced by Freeman Technology Ltd.). First, 10 g of an inorganic fine particle is weighed into a special cylindrical split vessel, and the inorganic fine particle is compressed at a predetermined pressure (30 kPa) with a compression test piston attached to the main body. The inorganic fine particle layer compressed in the split portion of the measurement vessel is leveled to remove the upper portion of the powder layer. Next, a special needle-shaped jig is attached to the main body and is penetrated into the powder layer in a vertical direction. During this process, the penetrating force is measured to obtain the compression energy (mJ).

### Measurement of Work Function of Inorganic Fine Particle

The work function of the inorganic fine particle is measured with a photoelectron spectrometer (AC-3 produced by RIKEN KEIKI Co., Ltd.). The inorganic fine particle is spread and placed on the measurement holder. The measurement conditions are as follows.
UV light source: deuterium lamp
Irradiation intensity: 150 nW
Spot size: 2×5 mm
Energy scan range: 4.0 eV to 7.0 eV
Measurement time: 10 sec/point

Measurement is performed under the aforementioned conditions, a calculation process is executed by using work function calculation software of the aforementioned device, and the work function of the inorganic fine particle is obtained as a result. The work function is measured at a repeated accuracy (standard deviation) of 0.02 eV.

### EXAMPLES

Examples and Comparative Examples will now be described to disclose the present disclosure in detail. The materials, the additives, the amounts used, the concentration, and the treatment method and procedure described below are subject to alterations as appropriate without departing from the gist of the present disclosure, and interpretations of the aspects of the present disclosure should not be limited by the contents of Examples below.

In the description below, “%” and “parts” are all on a mass basis unless otherwise noted.

### Production Example of Toner

### Production Example of Resin A

polyoxypropylene (2.2)-2,2-bis(4-hydroxyphenyl)propane: 76.3 parts by mass
terephthalic acid: 16.1 parts
succinic acid: 7.6 parts
titanium tetrabutoxide (esterification catalyst): 0.5 parts

Into a reactor vessel equipped with a condenser tube, a stirrer, a nitrogen inlet tube, and a thermocouple, the aforementioned materials were weighed.

Next, after the inside of the reactor vessel was purged with nitrogen gas, the temperature was elevated gradually under stirring, and the reaction was carried out for 4 hours under stirring at a temperature of 200° C. The pressure in the reaction vessel was reduced to 8.3 kPa and maintained thereat for 1 hour, then cooling was performed to 160° C., and the pressure was returned to atmospheric (first reaction step).
tert-butylcatechol (polymerization inhibitor): 0.1 parts

Subsequently, the aforementioned material was added, the pressure inside the reactor vessel was reduced to 8.3 kPa, and the reaction was carried out for 1 hour while maintaining the temperature of 180° C. After confirming that the softening point measured in accordance with ASTM D36-86 had reached 90° C., the temperature was decreased to terminate the reaction (second reaction step), as a result of which an amorphous resin A was obtained. The obtained resin A had a peak molecular weight Mp of 4500, a softening point Tm of 90° C., and a glass transition temperature Tg of 54° C.

### Production Example of Resin B

polyoxypropylene (2.2)-2,2-bis(4-hydroxyphenyl)propane: 74.8 parts by mass
terephthalic acid: 12.9 parts
adipic acid: 7.9 parts
titanium tetrabutoxide (esterification catalyst): 0.5 parts

Into a reactor vessel equipped with a condenser tube, a stirrer, a nitrogen inlet tube, and a thermocouple, the aforementioned materials were weighed.

Next, after the inside of the reactor vessel was purged with nitrogen gas, the temperature was elevated gradually under stirring, and the reaction was carried out for 2 hours under stirring at a temperature of 200° C. Then the pressure in the reaction vessel was reduced to 8.3 kPa and maintained thereat for 1 hour, then cooling was performed to 160° C., and the pressure was returned to atmospheric (first reaction step).
trimellitic acid: 5.9 parts
tert-butylcatechol (polymerization inhibitor): 0.1 parts

Subsequently, the aforementioned materials were added, the pressure inside the reactor vessel was reduced to 8.3 kPa, and the reaction was carried out for 15 hours while maintaining the temperature of 200° C. After confirming that the softening point measured in accordance with ASTM D36-86 had reached 140° C., the temperature was decreased to terminate the reaction (second reaction step), as a result of which an amorphous resin B was obtained. The obtained resin B had a peak molecular weight Mp of 10,000, a softening point Tm of 140° C., and a glass transition temperature Tg of 60° C.

### Production Example of Resin C

1,6-hexanediol: 33.9 parts
dodecanedioic acid: 66.1 parts

Into a reactor vessel equipped with a condenser tube, a stirrer, a nitrogen inlet tube, and a thermocouple, the aforementioned materials were weighed.

Next, after the inside of the reactor vessel was purged with nitrogen gas, the temperature was elevated gradually under stirring, and the reaction was carried out for 3 hours under stirring at a temperature of 140° C.
tin 2-ethylhexanoate: 0.5 parts

Subsequently, the aforementioned material was added, the pressure inside the reactor vessel was reduced to 8.3 kPa, and the reaction was carried out for 4 hours while maintaining the temperature of 200° C., as a result of which a crystalline resin C was obtained (first reaction step). The obtained resin C had a weight average molecular weight Mw of 11,000 and a fusion peak temperature Tp of 72° C.

### Production Example of the Dispersing Agent D

low-molecular-weight polypropylene (VISCOL 660P produced by Sanyo Chemical Industries, Ltd.): 10.0 parts
xylene: 25.0 parts

Into a reactor vessel equipped with a condenser tube, a stirrer, a nitrogen inlet tube, and a thermocouple, the aforementioned materials were weighed.

Next, after the inside of the reactor vessel was purged with nitrogen gas, the temperature was elevated gradually under stirring to 175° C.
styrene: 65.0 parts
cyclohexyl acrylate: 5.5 parts
butyl acrylate: 12.5 parts
methacrylic acid: 5.5 parts
xylene: 10.0 parts
di-t-butylperoxyhexahydroterephthalate: 0.5 parts

Subsequently, the aforementioned materials were added dropwise over a period of 3 hours, and the resulting mixture was further stirred for 30 minutes. Next, the solvent was distilled away to obtain a dispersing agent D in which a polyolefin is graft-polymerized with a styrene acrylic polymer. The dispersing agent D had a peak molecular weight Mp of 6000 and a softening point of 125° C.

### Production Example of Inorganic Fine Particles B1

After metatitanic acid produced by a sulfuric acid method was subjected to an iron-removal bleaching treatment, the pH was adjusted to 9.0 by adding an aqueous sodium hydroxide solution, and the resulting mixture was desulfurized, neutralized to a pH of 5.8 with hydrochloric acid, and filtered and washed with water. To the washed cake, water was added to prepare a 1.5 mol/L slurry of TiO₂, and hydrochloric acid was added thereto to adjust the pH to 1.5 and to perform a peptization treatment.

Metatitanic acid subjected to the desulfurization and peptization was collected as TiO₂ and placed in a 3 L reactor. To the peptized metatitanic acid slurry, an aqueous strontium chloride solution was added so that the SrO/TiO₂ molar ratio was 1.15, and then the TiO₂ concentration was adjusted to 0.8 mol/L.

Next, the resulting mixture was heated to 90° C. while stirring and mixing, 444 mL of a 10 mol/L aqueous sodium hydroxide solution was added thereto while micro-bubbling nitrogen gas at 600 mL/min over a period of 50 minutes, and then the resulting mixture was stirred for 1 hour at 95° C. while micro-bubbling nitrogen gas at 400 mL/min.

Then the resulting reaction slurry was rapidly cooled to 15° C. under stirring by flowing 10° C. cooling water over the jacket of the reaction vessel, and hydrochloric acid was added until the pH reached 2.0, followed by stirring for 1 hour. The obtained deposits were washed by decantation, 6 mol/L hydrochloric acid was added thereto to adjust the pH to 2.0, and 4.6 parts of 3,3,3-trifluoropropyltrimethoxysilane and 4.6 parts of i-butyltrimethoxysilane were added per 100 parts of the solid component, followed by stirring for 18 hours. The resulting mixture was neutralized with a 4 mol/L aqueous sodium hydroxide solution, stirred for 2 hours, separated by filtration, and dried in air at 120° C. for 8 hours to obtain an inorganic fine particle B1 in which the base was strontium titanate. The physical properties of the obtained inorganic fine particle B1 are indicated in Table 1.

### Production Example of Inorganic Fine Particles B2 to B5

Inorganic fine particles B2 to B5 were produced as with the inorganic fine particle B1 except that the type of the surface treating agent and the number of parts added were changed as indicated in Table 3. The physical properties are indicated in Table 1.

### Inorganic Fine Particle B6

A titanium oxide fine particle (ST-570 produced by Titan Kogyo, Ltd.) surface-treated with isobutyltrimethoxysilane was used as an inorganic fine particle B6. The physical properties are indicated in Table 1.

### Inorganic Fine Particle B7

A dry-process silica fine particle (X24-9600 produced by Shin-Etsu Chemical Co., Ltd.) surface-treated with hexamethyldisilazane was used as an inorganic fine particle B7. The physical properties are indicated in Table 1.

TABLE 1

| | | | | Physical properties | | |
|---|---|---|---|---|---|---|
| | | | | Number | | |
| | | Surface treating agent | | average | | |
| | | | No. of | particle | Compression | Work |
| | | | parts | diameter | energy | function |
| | Base | Type | added | (nm) | (mJ) | (eV) |
| Inorganic fine | Strontium | 3,3,3-Trifluoropropyltrimethoxysilane/ | 4.6 | 30 | 59 | 6.5 |
| particle B1 | titanate | i-butyltrimethoxysilane | 4.6 | | | |
| Inorganic fine | Strontium | i-Butyltrimethoxysilane | 8.0 | 30 | 59 | 6.5 |
| particle B2 | titanate | | | | | |
| Inorganic fine | Strontium | n-Octyltriethoxysilane | 8.0 | 30 | 59 | 6.5 |
| particle B3 | titanate | | | | | |
| Inorganic fine | Strontium | Silicone oil | 5.0 | 30 | 30 | 6.5 |
| particle B4 | titanate | | | | | |
| Inorganic fine | Strontium | — | — | 30 | 80 | 6.5 |
| particle B5 | titanate | | | | | |
| Inorganic fine | Titanium | i-Butyltrimethoxysilane | 4.0 | 30 | 20 | 6.3 |
| particle B6 | oxide | | | | | |
| Inorganic fine | Silica | Hexamethyldisilazane | 3.0 | 90 | 75 | 5.0 |
| particle B7 | | | | | | |

### Production Example of Toner 1

resin A: 62 parts
resin B: 28 parts
resin C: 10 parts
dispersing agent D: 4 parts
Fischer-Tropsch wax (peak temperature of the maximum endothermic peak: 90° C.): 4 parts
C.I. Pigment Blue 15:3: 7 parts

The aforementioned materials were mixed in a Henschel mixer (FM-75 model produced by Mitsui Mining Corporation) at a rotation speed of 20 s⁻¹ for a rotating time of 5 minutes, and then kneaded with a twin-screw kneader (PCM-30 model produced by IKEGAKI CO., LTD.) set at a temperature of 130° C. The kneaded material was cooled and roughly pulverized with a hammer mill to 1 mm or smaller to obtain a roughly pulverized material. The obtained roughly pulverized material was finely pulverized with a mechanical pulverizer (T-250 produced by TURBO KOGYO CO., LTD.). The finely pulverized material was further classified with FACULTY F-300 (produced by Hosokawa Micron Corporation) to obtain a toner particle. The operation conditions of FACULTY were that the rotation speed of the classification rotor was set to 130 s⁻¹ and the rotation speed of the dispersing rotor was set to 120 s⁻¹.

Into 100 parts of the obtained toner particle, 1.0 part of a hydrophobic silica particle (BET: 200 m²/g, compression energy: 85 mJ) was mixed with a Henschel mixer (FM-75 model produced by Mitsui Mining Corporation) at a rotation speed of 30 s⁻¹ and a rotating time of 10 minutes to obtain a toner particle mixture. To the obtained toner particle mixture, 0.6 parts of the inorganic fine particle B1 was added, and the resulting mixture was mixed with a Henschel mixer (FM-75 model produced by Mitsui Mining Corporation) at a rotation speed of 30 s⁻¹ and a rotating time of 1 minute to obtain a toner 1. The weight average particle diameter (D4) of the toner as measured by “CDA-1000X” (aperture diameter: 100 μm produced by Sysmex Corporation) was 5.8 μm. The average circularity of the toner as measured by a flow-type particle image analyzer, “FPIA-3000” (produced by Sysmex Corporation) was 0.963. The physical properties are indicated in Table 2.

### Production Example of Toner 13

To 100 parts of the toner particle obtained in Production example of toner 1, 1.0 part of a hydrophobic silica particle (BET: 200 m²/g, compression energy: 85 mJ) was added, and the resulting mixture was mixed with a Henschel mixer (FM-75 model produced by Mitsui Mining Corporation) at a rotation speed of 30 s⁻¹ for a rotating time of 10 minutes to obtain a toner 13.

The weight average particle diameter (D4) of the toner as measured by “CDA-1000X” (aperture diameter: 100 μm produced by Sysmex Corporation) was 5.8 μm. The average circularity of the toner as measured by a flow-type particle image analyzer, “FPIA-3000” (produced by Sysmex Corporation) was 0.963. The physical properties are indicated in Table 2.

### Production Examples of Toners 2 to 12

Toners 2 to 12 were obtained as in Production example of toner 1 except that the type and number of parts of the inorganic fine particle B added and the external addition conditions were changed as indicated in Table 2. The physical properties are indicated in Table 2.

TABLE 2

| | | | External | Physical |
|---|---|---|---|---|
| | | | addition | properties |
| | | | time for | Fixing ratio |
| | Inorganic fine particle B | | inorganic | of inorganic |
| | | No. of | fine | fine |
| Toner | | parts | particle B | particle B |
| No. | Type | added | (min) | (%) |
| Toner 1 | Inorganic fine particle B1 | 0.6 | 1 | 30 |
| Toner 2 | Inorganic fine particle B1 | 0.6 | 5 | 60 |
| Toner 3 | Inorganic fine particle B2 | 0.6 | 5 | 60 |
| Toner 4 | Inorganic fine particle B3 | 0.6 | 5 | 60 |
| Toner 5 | Inorganic fine particle B4 | 0.6 | 5 | 60 |
| Toner 6 | Inorganic fine particle B6 | 0.6 | 5 | 60 |
| Toner 7 | Inorganic fine particle B6 | 0.6 | 0.5 | 5 |
| Toner 8 | Inorganic fine particle B6 | 0.6 | 15 | 70 |
| Toner 9 | Inorganic fine particle B6 | 0.6 | 20 | 80 |
| Toner 10 | Inorganic fine particle B7 | 5.0 | 20 | 85 |
| Toner 11 | Inorganic fine particle B5 | 0.6 | 1 | 30 |
| Toner 12 | Inorganic fine particle B7 | 5.0 | 15 | 80 |
| Toner 13 | — | — | — | — |

### Production Example of Inorganic Fine Particle A1

To a glass reactor equipped with a stirring device and a dual dropping device, 100 parts of methanol and 16 parts of a 15% aqueous ammonia solution were added, and the resulting mixture was stirred under a nitrogen stream at 35° C. The rotation speed of the stirrer was adjusted to 150 rpm, and tetramethoxysilane and a 5.4% aqueous ammonia solution were simultaneously added dropwise. The dripping device was set so that the dropping rates were 31.1 parts per hour and 13.4 parts by hour, respectively. After tetramethoxysilane was added dropwise for 6 hours and the 5.4% aqueous ammonia solution was added dropwise for 5 hours, the resulting mixture was stirred for 10 minutes while keeping the temperature to obtain an inorganic fine particle base dispersion.

The inorganic fine particle base was recovered by suction filtration from the obtained inorganic fine particle base dispersion and heated in a 400° C. oven for 10 minutes to thereby obtain an inorganic fine particle base.

Into an autoclave, 100 parts of the obtained inorganic fine particle base was placed, and the inside of the autoclave was purged with nitrogen. While stirring the inorganic fine particle base in the autoclave, 0.7 parts of hexamethyldisilazane and 0.2 parts of distilled water atomized through a two-fluid nozzle were evenly sprayed. The autoclave was sealed, and the content was stirred for 30 minutes and then heated at 200° C. for 2 hours. Then the inside was depressurized while heating so as to obtain an inorganic fine particle A1 containing silica as the base. The physical properties of the obtained inorganic fine particle A1 are indicated in Table 3.

### Production Example of Inorganic Fine Particles A2 and A3

Inorganic fine particles A2 and A3 having different number average particle diameters were obtained as with the inorganic fine particle A1 except that the number of parts of methanol added was changed. The physical properties are indicated in Table 3.

### Inorganic Fine Particles A4 to A6

Commercially available barium titanates having different number average particle diameters were used as inorganic fine particles A4 to A6.

The physical properties are indicated in Table 3.

### Inorganic Fine Particle A7

A commercially available strontium titanate treated with n-octyltriethoxysilane was used as an inorganic fine particle A7. The physical properties are indicated in Table 3.

TABLE 3

| | | | | | Physical properties | |
|---|---|---|---|---|---|---|
| | | | | | Number | |
| | | | | | average | Work |
| Inorganic fine | | | | | particle | function |
| particle A | | | Product | Type of surface | diameter | WA |
| No. | Base | Manufacturer | name | treating agent | (nm) | (mJ) |
| Inorganic fine | Silica | — | — | Hexamethyldisilazane | 90 | 5.0 |
| particle A1 | | | | | | |
| Inorganic fine | Silica | — | — | Hexamethyldisilazane | 200 | 5.0 |
| particle A2 | | | | | | |
| Inorganic fine | Silica | — | — | Hexamethyldisilazane | 15 | 5.0 |
| particle A3 | | | | | | |
| Inorganic fine | Barium | Titan Kogyo, Ltd. | KY4-A2 | Silicone oil | 80 | 1.1 |
| particle A4 | titanate | | | | | |
| Inorganic fine | Barium | Titan Kogyo, Ltd. | KY4-A3 | Silicone oil | 100 | 1.1 |
| particle A5 | titanate | | | | | |
| Inorganic fine | Barium | Titan Kogyo, Ltd. | KY4-A1 | Silicone oil | 40 | 1.1 |
| particle A6 | titanate | | | | | |
| Inorganic fine | Strontium | Titan Kogyo, Ltd. | SW-535 | n-Octyltriethoxysilane | 80 | 5.8 |
| particle A7 | titanate | | | | | |

### Production Example of Magnetic Core Particle

### Step 1 (Weighing and Mixing Step)

Fe₂O₃: 68.3%
MnCO₃: 28.5%
Mg(OH)₂: 2.0%
SrCO₃: 1.2%

The above-described ferrite raw materials were weighed.

Next, 20 parts of distilled water was added to 80 parts of the ferrite raw material mixture, and the resulting mixture was pulverized and mixed in a ball mill with zirconia balls (φ10 mm) for 3 hours to obtain a slurry.

### Step 2 (Calcining Step)

The slurry was dried with a spray dryer (produced by OHKAWARA KAKOHKI CO., LTD.) and calcined in a nitrogen atmosphere (oxygen concentration: 1.0 vol %) in a batch-type electric furnace at a temperature of 1050° C. for 3.0 hours to obtain a calcined ferrite.

### Step 3 (Pulverizing Step)

The calcined ferrite was pulverized with a crasher to about 0.5 mm and then pulverized with a wet bead mill using ⅛ inch-diameter stainless beads for 3 hours. Then the resulting pulverized ferrite was pulverized in a wet ball mill for 4 hours using zirconia balls (1.0 mm) to obtain a calcined ferrite slurry.

### Step 4 (Particle Forming Step)

To 100 parts by mass of the calcined ferrite slurry, 1.0 part by mass of ammonium polycarboxylate and 1.5 parts of polyvinyl alcohol were added, and the resulting mixture was formed into 37 μm spherical particles with a spray dryer (produced by OHKAWARA KAKOHKI CO., LTD.). The obtained particles were heated in a rotary electric furnace at 700° C. for 2 hours.

### Step 5 (Firing Step)

In a nitrogen atmosphere (oxygen concentration: 1.0 vol %), the temperature was elevated from room temperature to a firing temperature (1100° C.) over a period of 2 hours, and the temperature of 1100° C. was retained for 4 hours to carry out firing. Then the temperature was decreased to 60° C. over a period of 8 hours, the atmosphere was returned to air from the nitrogen atmosphere, and the fired product was taken out at a temperature of 40° C. or lower.

### Step 6 (Selection Step)

The aggregated particles were disintegrated and sieved through a screen with 150 μm openings to remove coarse particles, and then fine powder was removed by air classification. The low magnetic component was removed by magnetic separation to obtain a magnetic core particle. The magnetic core particle observed with a scanning electron microscope SU8220 (produced by Hitachi High-Tech Corporation) was porous.

### Production Example of Magnetic Core Particle

Into a stirring vessel of a mixer/stirrer (universal stirrer NDMV model produced by DALTON Corporation), 100.0 parts of the aforementioned magnetic core particle was placed, and the inside of the stirring vessel was purged with nitrogen while keeping a temperature of 60° C. and decreasing the pressure to 2.3 kPa. Then 10.0 parts of a silicone resin solution (trade name: SR2410 produced by Dow Toray Co., Ltd.), 89.9 parts of toluene, and 0.1 parts of titanium n-butoxide were mixed and stirred in a multi blender mixer for 10 minutes. Here, the amount added dropwise was set to an amount equivalent to 7.5 parts in terms of the resin component. Then stirring was continued for 2 hours after completion of the dropwise addition. The temperature was further elevated to 70° C., the solvent was removed at a reduced pressure, and the pores in the magnetic core particle were filled with the silicone resin composition and the surface of the magnetic core particle was coated with the silicone resin composition. After cooling, the obtained particle was transferred to a mixer (drum mixer UD-AT produced by Sugiyama Heavy Industrial Co., Ltd.) equipped with a spiral blade in a rotatable mixing chamber, and the temperature was elevated to 220° C. at a temperature elevation rate of 2° C./min in a nitrogen atmosphere at a normal pressure. At this temperature, the mixture was heated and stirred for 60 minutes to cure the silicone resin. After the curing treatment, low magnetic products were separated by magnetic separation, and classification was conducted through a screen having 150 μm openings to obtain a carrier core particle filled with a silicone resin.

### Production Example of Resin Coating Solution

Into a four-necked flask equipped with a reflux condenser, a thermometer, a nitrogen suction tube, and a grinding type stirrer, 80 parts of cyclohexyl methacrylate and 20 parts methyl methacrylate were added.

Thereto, 100 parts of toluene, 100 parts of methyl ethyl ketone, and 2.0 parts of azobisisovaleronitrile were added. The resulting mixture was retained at 70° C. for 10 hours in a nitrogen stream to perform polymerization. Upon completion of the polymerization reaction, hexane was injected to induce precipitation and deposition of a copolymer, and precipitates were separated by filtration and vacuum-dried to obtain a coating resin.

To the obtained coating resin, toluene and methyl ethyl ketone were added at a ratio of 1:1 such that the solid component ratio was 5% to obtain a coating resin solution (solid content: 5%). Furthermore, 25 parts of the inorganic fine particle A1 was added to 2000 parts (resin solid component: 100 parts) of the coating resin solution, and the resulting mixture was shaken and stirred with a paint shaker (produced by RADIA) for 15 minutes to obtain a resin coating solution.

### Production Example of Magnetic Carrier Particle 1

magnetic core particle: 100 parts
resin coating solution: 40 parts

The aforementioned materials were charged into a planetary-screw mixer (Nauta mixer VN type produced by Hosokawa Micron Corporation) maintained at a temperature of 60° C. at a reduced pressure (1.5 kPa). The charging involved charging all of the magnetic core particle first, then charging ⅓ of the resin coating solution, and performing solvent removal and coating operation for 20 minutes. Next, another ⅓ of the resin coating solution was charged, solvent removal and coating operation were performed for 20 minutes, the last ⅓ of the resin coating solution was charged, and then solvent removal and coating operation were performed for 20 minutes.

Then the magnetic particle coated with the coating resin composition was transferred to a mixer (drum mixer UD-AT produced by Sugiyama Heavy Industrial Co., Ltd.) equipped with a spiral blade in a rotatable mixing chamber. The mixing chamber was rotated 10 times per minute to stir, and heat treatment was carried out in a nitrogen atmosphere at a temperature of 120° C. for 2 hours. The obtained particle was subjected to magnetic separation to separate low magnetic products, passed through a screen having 150 μm openings, and classified by air classifier to obtain a magnetic carrier particle 1. The physical properties of the obtained magnetic carrier particle 1 are indicated in Table 4.

### Production Example of Magnetic Carrier Particles 2 to 10

Magnetic carrier particles 2 to 10 were obtained as with the magnetic carrier particle 1 except that the type and number parts of the inorganic fine particle A added to the resin coating solution in Production example of magnetic carrier particle 1 were changed as indicated in Table 4. The physical properties are indicated in Table 4.

TABLE 4

| | | | Physical properties | |
|---|---|---|---|---|
| | Inorganic fine particle A added | | | Height HA of |
| | to coating resin solution | | Coverage XA | protrusion of |
| Carrier | | No. of | by inorganic | inorganic fine |
| particle | | parts | fine particle A | particle A |
| No. | Type | added | (area %) | (nm) |
| Carrier particle 1 | Inorganic fine particle A1 | 25 | 15 | 20.0 |
| Carrier particle 2 | Inorganic fine particle A4 | 25 | 15 | 20.0 |
| Carrier particle 3 | Inorganic fine particle A5 | 25 | 10 | 60.0 |
| Carrier particle 4 | Inorganic fine particle A6 | 25 | 10 | 8.5 |
| Carrier particle 5 | Inorganic fine particle A7 | 25 | 15 | 30.0 |
| Carrier particle 6 | Inorganic fine particle A2 | 25 | 15 | 100.0 |
| Carrier particle 7 | Inorganic fine particle A3 | 25 | 15 | 7.0 |
| Carrier particle 8 | Inorganic fine particle A1 | 70 | 60 | 20.0 |
| Carrier particle 9 | Inorganic fine particle A1 | 5 | 2 | 20.0 |
| Carrier particle 10 | — | — | — | — |

### Production Example of Two-Component Developer 1

To 92 parts by mass of the magnetic carrier particle 1, 8 parts by mass of the toner 1 was added and the resulting mixture was mixed in a V-type mixer (V-20 produced by SEISHIN ENTERPRISE CO., LTD.) for 5 minutes to obtain a two-component developer 1 containing the magnetic carrier particle 1, the toner particle, and the inorganic fine particle B1. The physical properties are indicated in Table 5.

Note that, because the toner 1 contained the toner particle and the inorganic fine particle B, the two-component developer contained the toner particle, the inorganic fine particle B, and the magnetic carrier. The same holds true for other two-component developers.

When the inorganic fine particle B was recovered from this two-component developer 1 by the water washing method, the amount of the inorganic fine particle B recovered per 100 parts by mass of the carrier was 0.03 parts by mass.

### Two-Component Developers 2 to 20

Two-component developers 2 to 20 were obtained by the same operation as in Production example of two-component developer 1 except that the magnetic carrier was changed to the combination indicated in Table 5. The physical properties are indicated in Table 5.

TABLE 5

| Two-component developer | Toner | Carrier particle | Physical properties | | | |
|---|---|---|---|---|---|---|
| No | No. | No. | XB | \|WA − WB\| | XB/XA | HB/HA |
| Two-component developer 1 | Toner 1 | Carrier particle 1 | 0.03 | 1.5 | 0.002 | 1.5 |
| Two-component developer 2 | Toner 2 | Carrier particle 1 | 0.02 | 1.5 | 0.001 | 1.5 |
| Two-component developer 3 | Toner 3 | Carrier particle 1 | 0.02 | 1.5 | 0.001 | 1.5 |
| Two-component developer 4 | Toner 4 | Carrier particle 1 | 0.02 | 1.5 | 0.001 | 1.5 |
| Two-component developer 5 | Toner 5 | Carrier particle 1 | 0.02 | 1.5 | 0.001 | 1.5 |
| Two-component developer 6 | Toner 6 | Carrier particle 1 | 0.02 | 1.3 | 0.001 | 1.5 |
| Two-component developer 7 | Toner 7 | Carrier particle 2 | 0.05 | 5.2 | 0.003 | 1.5 |
| Two-component developer 8 | Toner 8 | Carrier particle 2 | 0.01 | 5.2 | 0.001 | 1.5 |
| Two-component developer 9 | Toner 9 | Carrier particle 3 | 0.01 | 5.2 | 0.001 | 0.5 |
| Two-component developer 10 | Toner 9 | Carrier particle 4 | 0.01 | 5.2 | 0.001 | 3.5 |
| Two-component developer 11 | Toner 9 | Carrier particle 5 | 0.01 | 0.5 | 0.001 | 1.0 |
| Two-component developer 12 | Toner 10 | Carrier particle 5 | 0.05 | 0.8 | 0.003 | 3.0 |
| Two-component developer 13 | Toner 1 | Carrier particle 6 | 0.03 | 1.5 | 0.002 | 0.3 |
| Two-component developer 14 | Toner 1 | Carrier particle 7 | 0.03 | 1.5 | 0.002 | 4.3 |
| Two-component developer 15 | Toner 13 | Carrier particle 8 | 0.00 | — | — | — |
| Two-component developer 16 | Toner 1 | Carrier particle 9 | 0.03 | 1.5 | 0.015 | 1.5 |
| Two-component developer 17 | Toner 10 | Carrier particle 1 | 0.05 | 0 | 0.003 | 4.5 |
| Two-component developer 18 | Toner 11 | Carrier particle 1 | 0.03 | 1.5 | 0.002 | 1.5 |
| Two-component developer 19 | Toner 1 | Carrier particle 10 | 0.03 | — | — | — |
| Two-component developer 20 | Toner 12 | Carrier particle 5 | 0.09 | 0.8 | 0.006 | 3.0 |

### Evaluation Method

### (1) Evaluation of Image Quality

A full-color copying machine imagePRESS V1000 produced by CANON KABUSHIKI KAISHA was modified so that images could be output by using only the developing device at the cyan position. Furthermore, the copying machine was further modified so that the development contrast could be adjusted to any desired value and the image density automatic correction could not be executed by the main body. The image forming speed was set to 100 sheets/minute. The two-component developer was placed in a developing device at the cyan position, images were output, and various types of evaluation were conducted while performing a durability test. For evaluation paper, A4-size GF-C081 (81.4 g/m²) (Canon Marketing Japan Inc.) was used.

In a high-temperature, high-humidity environment (30° C., 80% RH), an image having a printing rate of 40% was output on 50,000 sheets of paper (A4 landscape). Then, a halftone image (A4 landscape, 30H) was output on one sheet. Here, a 30H image is a value hexadecimally indicating 256 tones and is a halftone image when 00H indicates solid white (no image) and FFH indicates solid black (full-sheet solid image). The dot area in the obtained halftone image was measured, and variation of the dot area was quantified (hereinafter referred to as a dot reproducibility index (I)) to evaluate the image quality.

The dot reproducibility index (I) was calculated as follows. By using digital microscope VHX-500 (lens: wide-range zoom lens VH-Z100 produced by Keyence Corporation), the areas of 1000 dots in the halftone image were measured. From the number-based average(S) and the standard deviation (c) of the obtained dot areas, the dot reproducibility index (I) was calculated by the following equation, and the image quality was evaluated according to the standard described below. The evaluation results are indicated in Table 6.

$$Dot reproducibility index ( I ) = σ / S \times 100$$

A: Dot reproducibility index (I) was less than 4.0.
B: Dot reproducibility index (I) was 4.0 or more and less than 6.0.
C: Dot reproducibility index (I) was 6.0 or more and less than 8.0.
D: Dot reproducibility index (I) was 8.0 or more.

### (2) Evaluation of Change in Image Density

A full-color copying machine imagePRESS C800 produced by CANON KABUSHIKI KAISHA was modified so that images could be output by using only the developing device at the cyan position. In addition, the mechanism that discharges the magnetic carrier, which became excessive in the developing device, from the developing device was removed. The two-component developer was placed in the developing device at the cyan position, and the toner was placed in the cyan toner container to perform the evaluation described below. For evaluation paper, A4-size GF-C081 (81.4 g/m²) (Canon Marketing Japan Inc.) was used. The coating amount of the toner on the paper in an FFH image (solid image) was adjusted to 0.45 mg/cm².

In a high-temperature, high-humidity environment (30° C., 80% RH), an image output test was carried out at a printing rate of 1% on 1,000 sheets. As 1,000 sheets were continuously passed, the same developing conditions and transfer conditions (no calibration) as those for the first sheet were kept. Then an image output test was carried out at a printing rate of 80% on 1,000 sheets. As 1,000 sheets were continuously passed, the same developing conditions and transfer conditions (no calibration) as those for the first sheet were kept.

The image density of the output image was measured with X-Rite color reflection densitometer (500 series produced by X-Rite, Incorporated). The image density of the 1,000th sheet in the image output test at a printing rate of 1% was defined as the initial density, the image density of the 1,000th sheet in the image output test at a printing rate of 80% was defined as the post-testing density, the absolute value (image density difference A) of the difference between the initial density and the post-testing density was calculated, and the change in image density was evaluated according to the following standard. Here, in measuring the density, measurement was repeated a number of times such that the measurement error was sufficiently small, and the arithmetic average thereof was employed as the measurement value. The evaluation results are indicated in Table 6.
A: The image density difference A was less than 0.02.
B: The image density difference A was 0.02 or more and less than 0.05.
C: The image density difference A was 0.05 or more and less than 0.10.
D: The image density difference A was 0.10 or more.

### (3) Evaluation of Charge Amount Retention Properties

The triboelectric charge quantity of the toner was determined by suctioning and collecting the toner on the electrostatic latent image bearing member with a metal cylindrical tube and a cylindrical filter.

Specifically, the triboelectric charge quantity of the toner on the electrostatic latent image bearing member was measured by using a Faraday cage. A Faraday cage is a coaxial double cylinder in which an inner cylinder and an outer cylinder are insulated from each other. When a charged body having a charge amount of Q is placed in the inner cylinder, electrostatic induction creates a state equivalent to the existence of a metal cylinder having a charge amount of Q. This induced charge amount is measured with an electrometer (KEITHLEY 6517A produced by KEITHLEY Instruments), the charge amount Q (mC) is divided by the mass M (kg) of the toner in the inner cylinder, and the result (Q/M) is defined as the triboelectric charge quantity of the toner.

$$Triboelectric charge quantity of toner ( mC / kg ) = Q / M$$

Evaluated image: A 2 cm×5 cm FFh image was placed at the center of A4 paper.

First, in a high-temperature, high-humidity environment (30° C., 80% RH), the aforementioned evaluation image was formed on an electrostatic latent image bearing member, the rotation of the electrostatic latent image bearing member was stopped before the evaluation image was transferred onto the intermediate transfer body, and the toner on the electrostatic latent image bearing member was suctioned and collected through a metal cylindrical filter and a cylindrical filter. Then Q/M (initial Q/M) on the electrostatic latent image bearing member at the initial stage was determined.

Subsequently, in a high-temperature, high-humidity environment (30° C., 80% RH), the evaluation copying machine (full-color copying machine imagePRESS C800 produced by CANON KABUSHIKI KAISHA) with the developing device remaining inside was left to stand still for 2 weeks, and then the same operation as before the standing was carried out to determine Q/M (Q/M after standing) on the electrostatic latent image bearing member after the standing. Then the Q/M retention rate after standing was calculated, and the charge amount retaining property was evaluated according to the following standard. Here, in measuring Q/M, measurement was repeated a number of times such that the measurement error was sufficiently small, and the arithmetic average thereof was employed as the measurement value. The evaluation results are indicated in Table 6.

$$Q / M retention rate ( \% ) = ( Q / M after standing ) / ( initial Q / M ) \times 100$$

A: The Q/M retention rate was 98% or more.
B: The Q/M retention rate was 95% or more and less than 98%.
C: The Q/M retention rate was 90% or more and less than 95%.
D: The Q/M retention rate was less than 90%.

TABLE 6

| | | Image quality | | Change in image | | Charge amount | |
|---|---|---|---|---|---|---|---|
| | Two-component | | Dot | density | | retention properties | |
| | developer | | reproducibility | | Image density | | Q/M retention |
| | No. | Rank | index (I) | Rank | difference Δ | Rank | rate (%) |
| Example 1 | Two-component | A | 2.5 | A | 0.01 | A | 99 |
| | developer 1 | | | | | | |
| Example 2 | Two-component | A | 3.1 | A | 0.01 | B | 97 |
| | developer 2 | | | | | | |
| Example 3 | Two-component | B | 4.3 | A | 0.01 | A | 99 |
| | developer 3 | | | | | | |
| Example 4 | Two-component | A | 2.6 | B | 0.02 | A | 99 |
| | developer 4 | | | | | | |
| Example 5 | Two-component | A | 2.6 | B | 0.03 | B | 97 |
| | developer 5 | | | | | | |
| Example 6 | Two-component | B | 4.6 | B | 0.02 | A | 99 |
| | developer 6 | | | | | | |
| Example 7 | Two-component | B | 4.5 | A | 0.01 | B | 96 |
| | developer 7 | | | | | | |
| Example 8 | Two-component | B | 4.7 | B | 0.03 | B | 95 |
| | developer 8 | | | | | | |
| Example 9 | Two-component | B | 5.0 | B | 0.04 | C | 92 |
| | developer 9 | | | | | | |
| Example 10 | Two-component | B | 5.1 | C | 0.05 | B | 95 |
| | developer 10 | | | | | | |
| Example 11 | Two-component | B | 5.5 | C | 0.05 | C | 93 |
| | developer 11 | | | | | | |
| Example 12 | Two-component | C | 6.2 | C | 0.07 | C | 91 |
| | developer 12 | | | | | | |
| Comparative | Two-component | D | 8.0 | C | 0.06 | C | 90 |
| Example 1 | developer 13 | | | | | | |
| Comparative | Two-component | C | 6.4 | D | 0.11 | C | 92 |
| Example 2 | developer 14 | | | | | | |
| Comparative | Two-component | C | 7.1 | C | 0.09 | D | 89 |
| Example 3 | developer 15 | | | | | | |
| Comparative | Two-component | D | 8.4 | D | 0.12 | C | 91 |
| Example 4 | developer 16 | | | | | | |
| Comparative | Two-component | D | 8.5 | D | 0.12 | D | 88 |
| Example 5 | developer 17 | | | | | | |
| Comparative | Two-component | D | 8.1 | C | 0.09 | D | 86 |
| Example 6 | developer 18 | | | | | | |
| Comparative | Two-component | D | 8.3 | D | 0.14 | D | 86 |
| Example 7 | developer 19 | | | | | | |
| Comparative | Two-component | D | 8.5 | D | 0.13 | D | 84 |
| Example 8 | developer 20 | | | | | | |

According to the present disclosure, there can be provided a two-component developer capable of suppressing the decrease in charge amount of the developer caused by degraded durability of the developer in a high-temperature, high-humidity environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205846, filed Nov. 26, 2024, which is hereby incorporated by reference herein in its entirety.

What is claimed is:

1. A two-component developer comprising:
a toner particle;
a magnetic carrier particle; and
an inorganic fine particle B,
wherein the magnetic carrier particle includes a magnetic core particle and a coating resin layer coating a surface of the magnetic core particle,
the coating resin layer includes an inorganic fine particle A,
at least part of the inorganic fine particle A is exposed on a surface of the magnetic carrier particle,
XB (parts by mass) representing a recovery amount of the inorganic fine particle B recovered from the two-component developer by a water washing method is 0.01 parts by mass to 0.05 parts by mass per 100 parts by mass of the magnetic carrier particle,
the inorganic fine particle B has a compression energy of 75 mJ or less as measured in a state of a powder layer formed by compression at 30 kPa,
WA (eV) representing a work function of the inorganic fine particle A and WB (eV) representing a work function of the inorganic fine particle B satisfy formula (1):
$$0.5 \leq \vert WA - WB \vert \leq 10. , \qquad ( 1 )$$
XA (area %) representing a coverage of the surface of the magnetic carrier particle by the inorganic fine particle A and the XB satisfy formula (2):
$$0.001 \leq XB / XA \leq 0.0 \; 10 , \qquad ( 2 )$$
and
HA (nm) representing an average value of a height of a protrusion of the inorganic fine particle A exposed on the surface of the magnetic carrier particle and HB (nm) representing a number average particle diameter of primary particles of the inorganic fine particle B recovered by the water washing method satisfy formula (3):
$$0.5 \leq HB / HA \leq 4. . \qquad ( 3 )$$

2. The two-component developer according to claim 1, wherein the inorganic fine particle A is a silica fine particle.

3. The two-component developer according to claim 1, wherein the inorganic fine particle B is a strontium titanate fine particle.

4. The two-component developer according to claim 1, wherein the inorganic fine particle B is a surface-treated inorganic fine particle treated with a surface treating agent, and the surface treating agent is at least one selected from the group consisting of a silane coupling agent, a fluorosilane coupling agent, a fatty acid, and a fatty acid metal salt.

5. A method for producing a two-component developer, the method comprising:
a step of obtaining a toner particle mixture by mixing a toner particle and an external additive other than an inorganic fine particle B;
a step of obtaining a toner by mixing the toner particle mixture and the inorganic fine particle B; and
a step of obtaining a two-component developer by mixing the toner and a magnetic carrier particle,
wherein the obtained two-component developer includes the toner particle, the magnetic carrier particle, and the inorganic fine particle B,
the magnetic carrier particle contains a magnetic core particle and a coating resin layer coating a surface of the magnetic core particle,
the coating resin layer includes an inorganic fine particle A,
at least part of the inorganic fine particle A is exposed on a surface of the magnetic carrier particle,
XB (parts by mass) representing a recovery amount of the inorganic fine particle B recovered from the two-component developer by a water washing method is 0.01 parts by mass to 0.05 parts by mass per 100 parts by mass of the magnetic carrier particle,
the inorganic fine particle B has a compression energy of 75 mJ or less as measured in a state of a powder layer formed by compression at 30 kPa,
WA (eV) representing a work function of the inorganic fine particle A and WB (eV) representing a work function of the inorganic fine particle B satisfy formula (1):
$$0.5 \leq \vert WA - WB \vert \leq 10. \qquad ( 1 )$$
XA (area %) representing a coverage of the surface of the magnetic carrier particle by the inorganic fine particle A and the XB satisfy formula (2):
$$0.001 \leq XB / XA \leq 0.0 \; 10 , \qquad ( 2 )$$
and
HA (nm) representing an average value of a height of a protrusion of the inorganic fine particle A exposed on the surface of the magnetic carrier particle and HB (nm) representing a number average particle diameter of primary particles of the inorganic fine particle B recovered by the water washing method satisfy formula (3):
$$0.5 \leq HB / HA \leq 4. . \qquad ( 3 )$$
